(19) United States
(12) Patent Application Publication
(10) Pub. No.: US 2010/0088410 A1
(43) Pub. Date: Apr. 8, 2010

(54) Wireless Broadband Network Management

(75) Inventor: Phillip Allan Ridley, New South Wales (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ubo Wireless Pty Limited, A.C.N., Sydney (AU)

(21) Appl. No.: 12/597,459

(22) PCT Filed: Mar. 11, 2008
(86) PCT No.: PCT/AU08/00330

§ 371 Date: Dec. 14, 2009

(30) Foreign Application Priority Data
Apr. 30, 2007 (AU) 2007202006

(51) Int. Cl. G06F 15/16

(52) U.S. Cl. 709/224; 709/226

(57) ABSTRACT

This invention concerns the management of wireless broadband networks. In particular the invention concerns a wireless broadband network management system comprising a data collection engine to collect data concerning traffic levels through the network base transceiver stations (BTSs), and the BTSs to which particular customer premise equipment (CPE) can connect; and a processor to correlate the data collected; to monitor overall network performance; to aggregate performance of one or more CPEs and BTSs; to detect underperforming BTSs and CPEs; and to automate CPE connections and disconnections to improve network performance in real time. In another aspect, the invention is a method for managing broadband networks. In further aspect, the invention is a software to implement the method.

### TECHNICAL FIELD

This invention concerns the management of wireless broadband networks. In particular the invention concerns a wireless broadband network management system that is able to change connections in a network to better balance the load. In another aspect, the invention is a method for managing broadband networks. In further aspect, the invention is a software to implement the method.

### BACKGROUND ART

Wireless broadband networks are created by setting up an array of base stations or base transceiver stations (BTS) throughout the coverage area, and implementing a radio frequency (RF) access technology among them. Subscribers within coverage then access the network using customer premise equipment (CPE), wireless modems or mobile stations.

Navini Ripwave element management system (EMS) is one example of RF access technologies currently in use to configure and provision BTSs and CPEs. Navini BTSs implement a set of rules that describe what should occur when CPEs on different descriptors, which primarily relate to plan speed, all compete for finite resources on a BTS. There are several actions possible when a BTS is congested:
Active and idle rotation.
Allocation of fewer resources per CPE down to a minimum profile.
Quality of Service enforcement.
And, forcing CPEs to drop off and conduct their own search for an alternative BTS.

This BTS congestion management theme is based on forcing CPEs to contend for resources according to fixed sets of peer groups, and the closest approximation to this behaviour is an algorithm known as Max-Min balancing.

CPEs are smart RF devices, with their own decision-making capabilities and cannot be forced to do anything. If a CPE is not happy with the current RF quality and resource allocation, it will simply detach itself and search for a new BTS to attach to. Therefore, CPE behaviour is not deterministic. In addition, the CPEs must stay configured as nomadic at all times in order to maintain service portability anywhere within coverage.

All data gathered from such a network is extremely ‘noisy’, and in addition there are periodic daily, weekly, and seasonal traffic peaks to manage, as well as vastly differing spatial or locality-based load demands across the network.

The CPEs also have greatly different bandwidth demand behaviour, and there are descriptors in both upload and download paths varying from 32 Kbps up to 1024 Kbps. This has a corresponding resource demand on the air interface of the BTS, a scarce resource to be carefully managed.

It is not possible to inspect the current list of visible BTSs to a particular CPE as no interface for this exists.

BTS loads themselves can vary wildly every 15 minutes from moderately busy to completely overloaded and vice versa.

Due to physical environment and localised settings, not all BTSs are equivalent in performance. Besides, there is often no single definition of overall BTS load indicator, or resource usage indicator, as there are many possible resource bottlenecks, but there is usually an indicator that defines congestion when this point is reached. In the case of Navini Ripware, the indictor is the Reject Ratio (RR) of users.

There are two main influences on overall CPE link speed: BTS congestion and RF path. BTS congestion affects different descriptors, CPE speeds, at different levels of deterioration in descriptor speed per BTS, but RF path is unique to each CPE. When BTSs are congested, rarified access to air interface resources affects overall CPE throughout more than RF path does for broadband customers.

### DISCLOSURE OF THE INVENTION

The invention is a wireless broadband network management system, comprising:
A data collection engine to collect data concerning traffic levels through the network base transceiver stations (BTSs), and the BTSs to which particular customer premise equipment (CPE) can connect.
A processor to correlate the data collected; to monitor overall network performance; to aggregate performance of one or more CPEs and BTSs; to detect underperforming BTSs and CPEs; and to automate CPE connections and disconnections to improve network performance in real time.

The data may be collected from element management systems in communication with the system; the data includes one or more of BTS performance data, logs of the element management systems, and CPE registration and migration history.

The system may change connections between the BTSs and the CPEs according to two regimes operating in tandem, where:
the first regimen selects CPEs and attempts to move them from busy BTSs to less busy BTSs; and
the second regimen filters CPE registration attempts on busy BTSs to divert the CPEs to less busy BTSs, to better balance the load

At any cycle of the load balancing event, the system may perform the following:
creating a BTS load matrix;
minimising the matrix using BTS-CPE connectivity data;
using extrapolation techniques to create a future estimated snapshot of the network load if a CPE is moved;
comparing the estimated snapshot to a target bandwidth to move;
and then creating a difference or perturbation matrix.

The target bandwidth to move may depend on the total resource usage of all CPEs according to their profiles, and a time-varying gain factor to take into account dynamic CPE traffic demands.

A CPE may be moved from an original BTS to a new BTS if the load level of the new BTS is lower level than the load level of the original BTS; and the two BTSs are sufficiently different, that is the load level difference between the BTSs is at least a minimum load level difference.

The two load balancing regimes may operate in one of the following modes:
an overlay mode, where a CPE is moved to a new BTS that has a direct capacity overlay as its original BTS; and
an overlay plus adjacent sector mode, where a CPE is moved to a new BTS that has a direct capacity overlay as its original BTS, or has an adjacent sector to its original BTS.

The system may effect connection changes by:
telling a CPE that the BTS it is attached to is no longer a valid BTS allowed to service this CPE, and that the CPE is no longer nomadic.
probing the CPE which action initiates a CPE-driven BTS search, and it will then attach to BTSs it can see until it eventually ‘lands’ on the desired target BTS.
at that time setting the CPE to Nomadic with Preferred, with its Home BTS and Neighbouring BTS settings configured to prefer it to the new target BTS, and away from the original BTS;
and finally several tracking tasks are then created to watch the CPE over time and update any statistics for reference when contemplating future moves.

The system may operate in cycles during which it collects data and attempts to apply connection changes; a cycle may last 15 minutes.

At peak times the system may move up to a configurable cycle rate, for example, 50 CPEs per cycle. The system only acts when it needs to intervene. It also tries to reduce its own workload over time by creating settled populations of CPEs that will stay on the optimal BTSs even after the CPE has been reset or power recycled.

The system may further comprise a plurality of canaries programmed to receive commands from the system to run a series of tests to assess the network performance from the end customer point of view and report the results to the system. The tests may include Voice Over Internet Protocol (VOIP), Mean Opinion Score (MOS), HTTP throughput, packet loss, jitter and latency tests.

The system further performs regression tracking on the traffic data collected to track changes in network performance.

The system further uses the correlated data to compute a resource usage ratio representing the air interface efficiency between a CPE and a BTS. The resource usage ratio to detect CPEs that violate their acceptable usage policy and when a violating CPE is detected, the system performs one or more of the following:
changing the speed descriptor of the CPE to a lower minimum resource allocation;
dropping the CPE to a lower descriptor class of service until the CPE complies with its acceptable usage policy;
sending warning messages to the CPE;
placing the CPE as the first choice of being moved to a new BTS, and increasing the number of times this CPE can be disturbed over time; and,
disabling the CPE.

The system may further analyse aggregate performance data of one or more CPEs and BTSs to answer natural language queries.

The system may further perform BTS performance optimisation, comprising the steps of:
extracting BTS performance data from the data collected;
inferring BTS optimal settings for a variety of operating conditions,
computing an optimal settings for each BTS based known relationships among the BTSs, and
tuning the BTS settings and changing CPE connections to achieve the optimal settings computed.

The system may cope with hundreds of BTSs, tens of thousands of CPEs, and tens of sets of BTS overlays being balanced at once.

The system may also detect interference in the network based on CPE and BTS registration data.

The system may calculate network performance and quality indicators based on network revenue, CPE performance and BTS efficiency.

Communication between a BTS and a plurality of CPEs may be via a broadcast or unicast.

The system may be able to process a number of network statistics on:
BTS load state and demand to facilitate load balancing,
BTS throughput related to facilitate load balancing,
BTS perturbation that represents CPE migration among a group of two or more BTSs,
BTS equivalence that measures the mass population movement of CPEs between BTSs,
BTS resource usage,
CPE disturbance that represents the history of CPE migration to facilitate load balancing,
CPE affinity with a BTS to facilitate load balancing,
CPE migration and return and migration success ratio to facilitate load balancing,
CPE resource usage to record resource-wasting CPEs, and
CPE performance that is used to troubleshoot end customer connectivity or other service quality-related issues.

In a further aspect, the invention is a method for managing wireless broadband networks, comprising the steps of:
collecting data concerning traffic levels through the network base transceiver stations (BTSs), and the BTSs to which particular customer premise equipment (CPE) can connect using a data collection engine;
correlating the data collected;
monitoring overall network performance;
aggregating performance of one or more CPEs and BTSs;
detecting underperforming BTSs and CPEs; and
and automatically causing CPE connections and disconnections from a BTS to improve network performance in real time.

In another aspect, the invention is a software to implement the method.

Advantageously, the invention provides a comprehensive and fully integrated business intelligence system, optimisation system and learning network management system to monitor, manage and optimise the performance of a network. The invention enables network operators to monitor, analyse, and manipulate network elements from the micro to the macro, from individual CPEs to the load on the entire structure of the network.

The invention may be used as a management and planning tool to:
identify BTSs that are under stress;
measure data traffic and relate it back to network stress;
monitor BTS health including power, internal capacity and resource allocation activities;
supply historical data that can be used to forecast expansion timeframes;
facilitate dynamic optimisation;
assist with “what if” analyses by using historical data;
collect real time data from any system that has any information about the network;
run an application that correlates this data and performs fuzzy logic and other signal processing data analysis techniques to identify relationships;
exploit the processed information to make real-time decisions about what actions we can take to improve performance;
automate various business tasks in real-time;
automate various radio frequency optimisation activities;
exploit short, medium and long term trend data to identify weaknesses and system anomalies; and
gather a wide range of correlated historical customer premises equipment and baste station data for accurate end customer problem diagnosis and service restoration.

This is achieved by using powerful signal processing and artificial intelligence techniques to make smart, real-time decisions about network performance options that improve customer connections, optimise network capacity and planning, and reduce operational costs in order to achieve faster return on network investment.

Using the invention, wireless broadband companies may:
improve customer connections, service and retention;
improve capacity capability on the network;
improve return on investment by best managing capacity enhancements;
improve planning capabilities;
reduce call centre costs, and
slow the need for further capital expansion costs.

The invention is also an optimisation system that arms network engineers with a powerful set of tools that:
provides accurate data to support static optimisation activities;
facilitates dynamic optimisation;
collects and stores data for historical reports and performance analysis metrics to investigate the effects of tuning activities, such as mass software update downloads;
enables and automates activities impossible to conduct manually, such as real-time traffic equalisation and migration studies; and
allows network engineers to be able to set the parameters and metrics that best suit their network and monitor its performance.

The direct gains of using the invention are improved performance for individual CPEs and the abilities to measure and act against anomalous behaviour in the network and to balance traffic between heavily and lightly loaded base stations. Additionally, network operators also benefit from improved return on investment (ROI) and higher average customer count per BTS.

The indirect gains are the ability to gain an overall picture of network performance and report on impacts of other changes such as the introduction of new software, the introduction of new sites and base stations and changes in antenna azimuth and tilts to solve potential interference issues.

In addition, the invention enables the customer service representatives on the Help Desk to:
troubleshoot customer modem performance with greater accuracy;
proactively identify CPEs with poor performance or radio service;
investigate CPE performance statistics and track connections statistics;
move modems between base stations;
visually understand what a customers' issue is and review historic performance when a call is received;
optimise CPE connections with preferred settings, and
update CPE software.

Using this invention, a concept called virtual CSR emerges. The invention automates as many of the manual activities usually performed by CSRs as possible without requiring interactive customer contact, and helps to pre-empt customer dissatisfaction. Customer dissatisfaction can be preempted by automatically analysing every customer's connection quality and speed over time, and instantly fix or flag CPEs whose service quality is detected as recently deteriorated significantly.

Advantageously, the system is robust and stable enough to deal with short term network anomalies, such as site, cluster or network-wide resets and recalibrations, without losing track of what it was doing or diverging.

### BRIEF DESCRIPTION OF THE DRAWINGS

An example of the invention will now be described with reference to the accompanying drawings, in which:

FIG. 1 is a diagram of a wireless broadband network.

FIG. 2 is a diagram of the architecture of the wireless broadband network management system exemplifying the invention.

FIG. 3 is a screenshot of the wireless broadband network management system interface exemplifying the invention.

FIG. 4 is a screenshot of the load balancer interface.

FIG. 5 is an example of a BTS-CPE load matrix.

FIG. 6 is an example of a preemptive polynomial curve.

FIG. 7 is a flowchart of the Attempt Move algorithm.

FIG. 8 is a flowchart of the opportunistic load balancing algorithm.

FIG. 9 is a flowchart of the forced load balancing algorithm.

FIG. 10(a) is an affinity cache timeout plot and FIG. 10(b) is a time-varying affinity decision plot.

FIG. 11 is an example of a perturbation plot.

FIG. 12 is a screenshot of the active BTS statistics feature of the load balancer.

FIG. 13 is a screenshot of the throughput monitoring feature of the load balancer.

FIG. 14 is a screenshot of the perturbation monitoring feature of the load balancer.

FIG. 15 is a screenshot of the CPE disturbance monitoring feature of the load balancer.

FIG. 16 is a screenshot of the BTS equivalence monitoring interface.

FIG. 17 is a screenshot of the CPE resource usage monitoring interface.

FIG. 18 is a screenshot of the CPE performance monitoring interface.

FIG. 19 is a screenshot of the BTS resource monitoring interface.

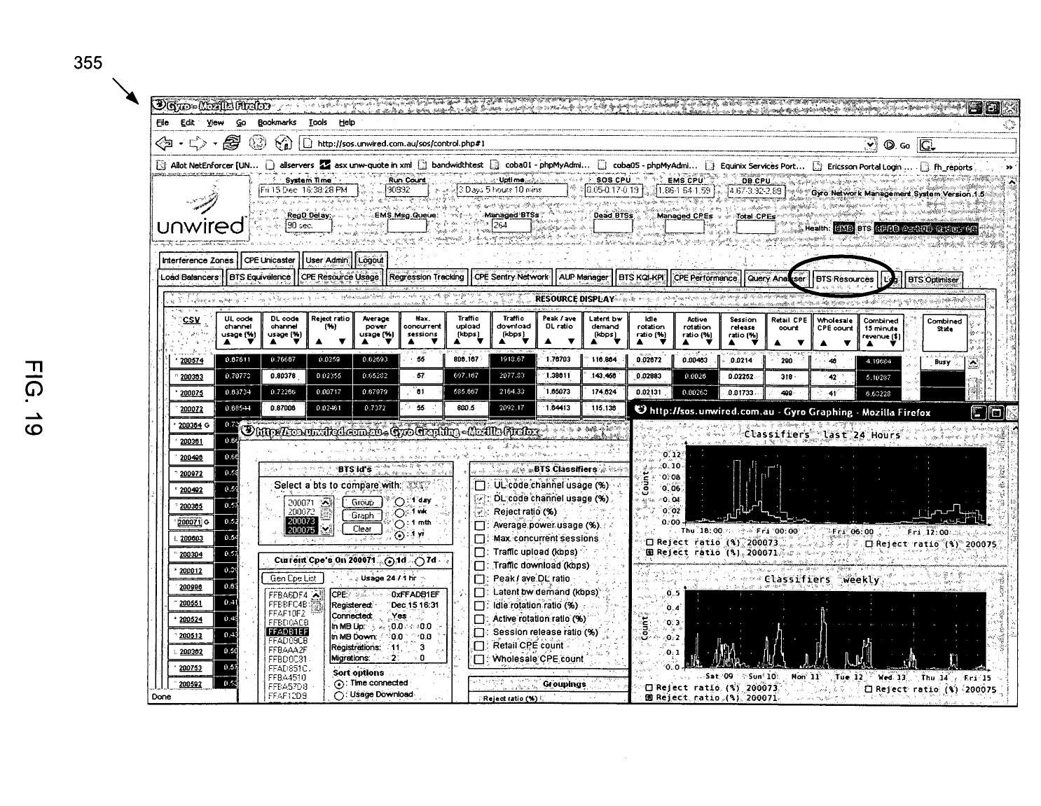

### BEST MODES OF THE INVENTION

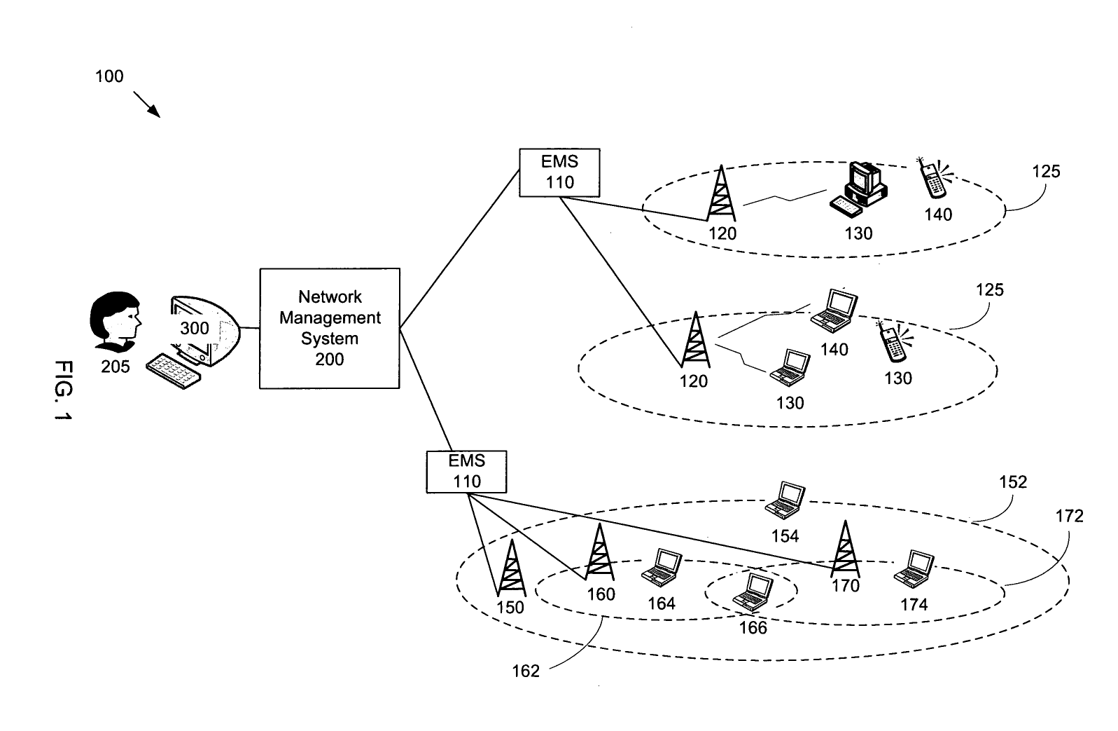

Referring first to FIG. 1, the wireless broadband network 100 comprises a network management system 200 (the system) in communication with a plurality of Element Management Systems (EMSs) 110 which manage a plurality of Base Transceiver Stations (BTSs) 120; and Customer Premise Equipments (CPEs) 130. Each BTS 120 has its own coverage area 125 and is able to service any CPEs that are within the area.

BTSs may have overlapped coverage areas. For example, the coverage area 152 of BTS 150 also encompasses the smaller coverage areas 162 and 172 of BTSs 160 and 170, respectively. Suppose that BTS 150 is serving CPE 154; BTS 160 is serving CPEs 164 and 166 while BTS 170 is serving 174. CPEs 164 and 174 are also within the coverage area 152 while CPE 166 is also within the coverage areas of both BTSs 150 and 170. Such overlay architecture enables load to be redistributed among BTSs 150, 160 and 170 during congestion. For example, when BTS 160 is overloaded, CPE 166 may be moved to either BTS 150 or 170.

The system 200 is also in communication of a plurality of devices 140 called canaries, which are placed around the network to assess network performance from the point of view of customers.

### Application Architecture

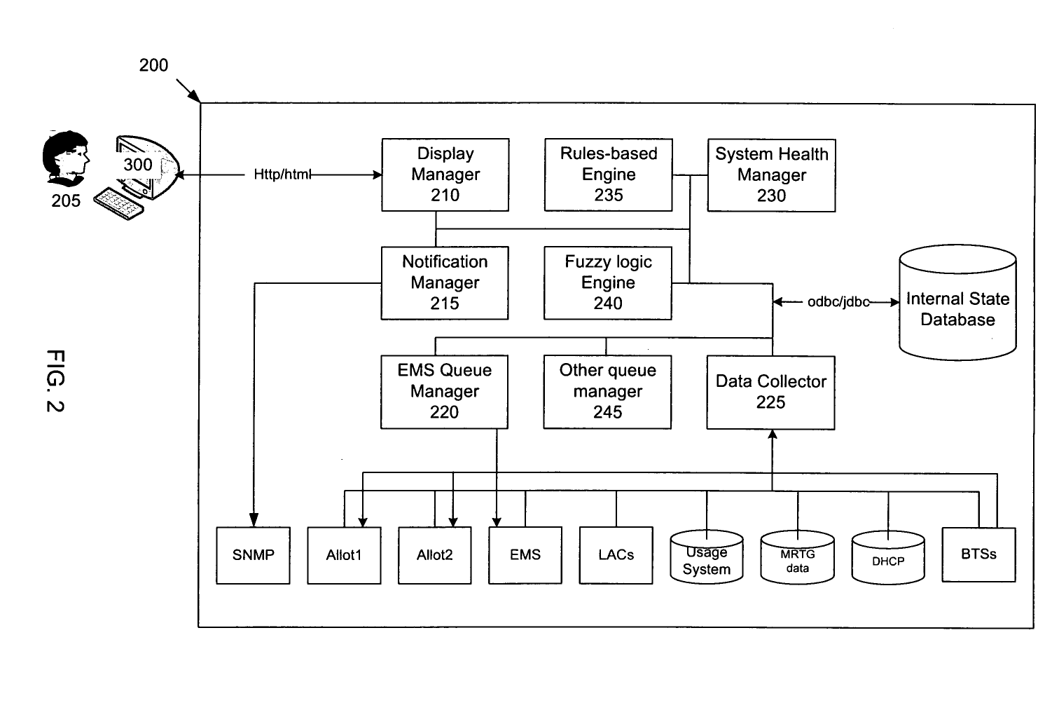

The application architecture of the system 200 is designed as a collection of individual units; see FIG. 2. The architecture comprises the following components:
Display manager 210.
Notification manager 215.
EMS Queue manager 220.
Data collector 225.
System health manager 230.
Rules-based engine 235,
Fuzzy logic engine 240.
Other queue manager 245.

Data collector 225 engine gathers, monitors and processes multilayer data such as BTS performance data, EMS system logs, IP traffic, CPE air-interface connectivity, connection history and customer database, and combines the data streams into one stream for correlation.

The data is extracted from industry-standard databases such as a usage system database, a Multi-Router Traffic Grapher (MRTG) database and a Dynamic Host Configuration Protocol (DHCP) database to be stored in an internal state database.

The system 200 then uses two types of search decisions to analyse the data:
standard data mining techniques using SQL, and pre-coded functions for answering specific question, and
artificial intelligence and fuzzy logic techniques to discover trends and make complex decisions where usual logic cannot be used.

The system is designed to run on the Linux platform and works well with the Navini Corba API, so it can interact with the element management system. The system also works well with web services, php, AJAX, java and MySQL technology.

The system 200 then conducts mathematical analysis on the data using artificial intelligence data processing techniques of rules-based engine 235 and fuzzy logic engine 240. Fuzzy logic engine 240, also known as classifier engine, has learning capabilities and runs a sequence of strong and weak classifier algorithms for issue detection and decision making.

### Interface 300

Display manager 210 provides an interface 300 to the system 200 for system users 205 to monitor, configure, troubleshoot and control the wireless broadband network 100. System users 205 may be network engineers who configure and monitor the performance of the network or customer service representatives who deal with customer enquiries and perform troubleshooting.

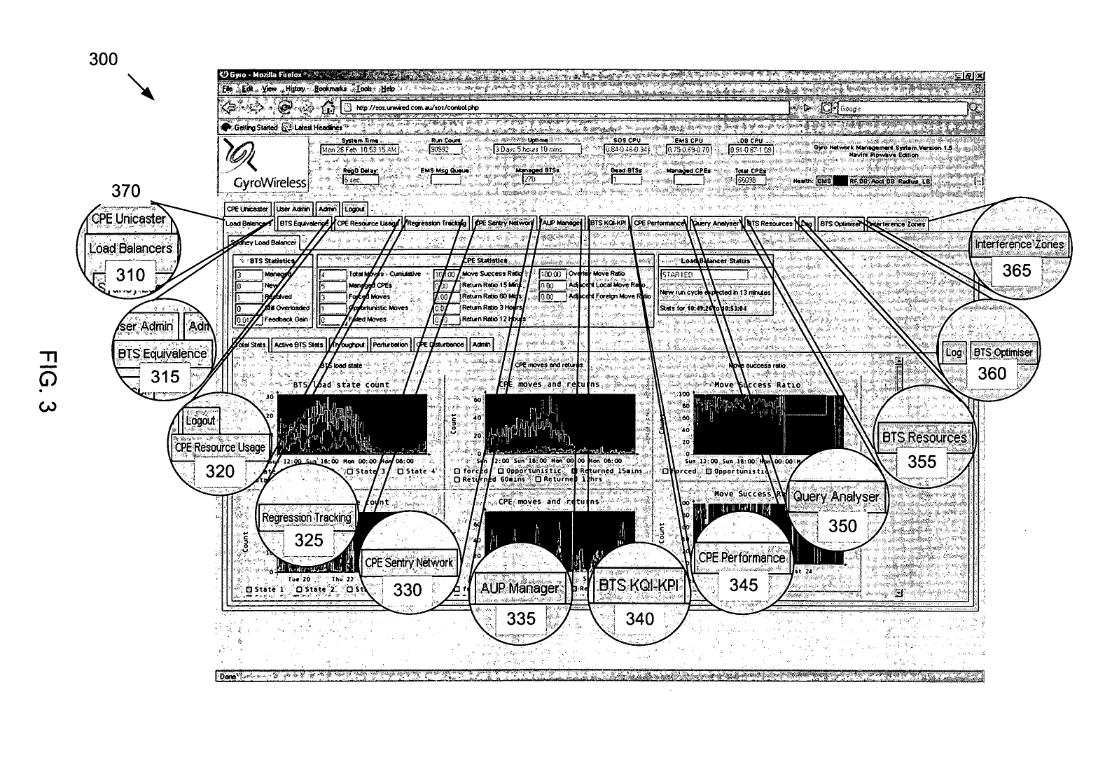

Referring now to FIG. 3, the interface 300 comprises the following features:
Load Balancer 310,
BTS Equivalence 315,
CPE Resource Usage Monitor 320,
Regression Tracking 325,
CPE Sentry Network 330,
Acceptable Usage Policy (AUP) Manager 335,
BTS Key Quality Indicator-Key Performance Indicator (KQI-KPI) 340,
CPE Performance Monitor 345,
Query Analyser 350,
BTS Resource Monitor 355,
BTS Optimiser 360,
Interference Zones Monitor 365, and
CPE Unicaster 370.

### Load Balancer 310

Load balancer 310 is an application designed to redistribute traffic between BTSs in differing load states in real time by moving CPEs between them. The end goal is to arrive at equally loaded capacity overlays, and reduced peak load overall on any one BTS.

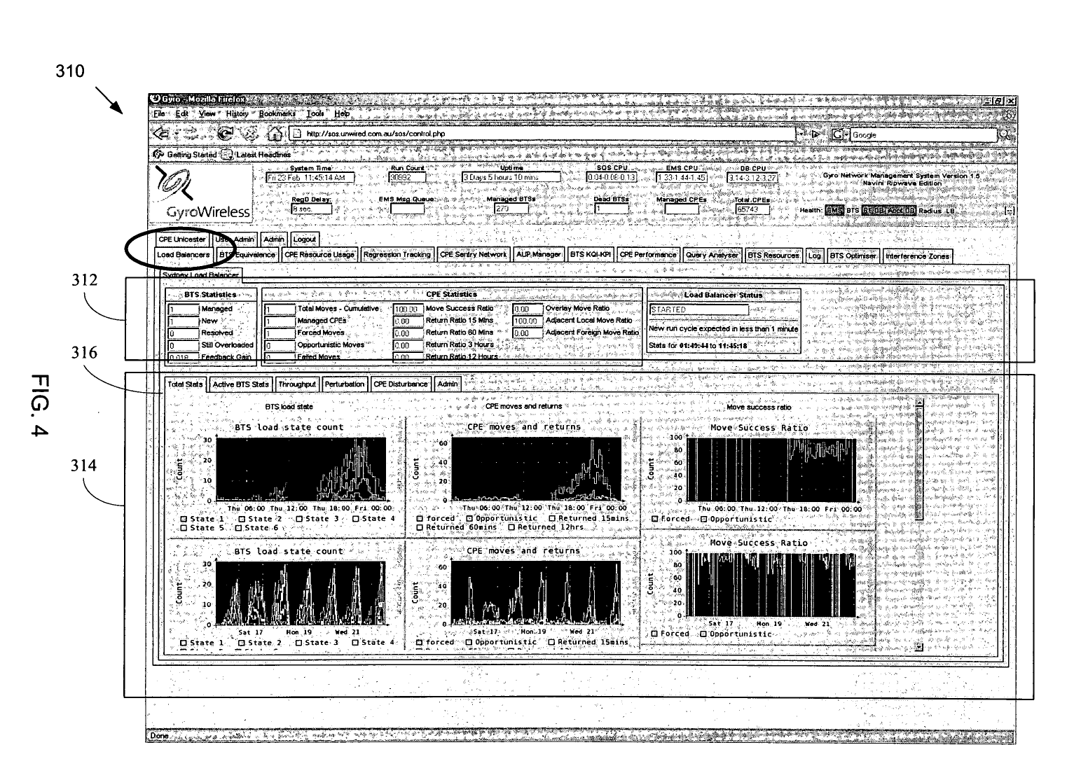

The load balancer is implemented using a java-based daemon that runs on the EMS and carries out actions according to central commands. The load balancer is configured via the interface shown in FIG. 4, its configuration is defined in coba08's rfoptimise database. It takes real-time data feeds from CPE registration and migration data and the classifier engine 240, to ascertain BTS load state in order to make decisions.

The load balancer is by necessity both BTS-centric and CPE-centric. As some BTSs are more or less equivalent in terms of their coverage area, the load balancer seeks to equalize the load between them, but can only do so by influencing CPEs that can see at least two BTSs in the tuple. Such CPEs are theoretically moveable, but the load balancer requires heuristic data about both BTS equivalence and CPE connectivity, as well as a real time processor. CPEs cannot be sent to sectors where they are not going to be stable, so the load balancer requires prior knowledge to make an educated risk judgment each time.

The load balancer is a slow acting system; that is, it is specifically designed to take up to several weeks to achieve its end goal. It also is designed as a lazy system. The load balancer only acts when it needs to intervene. It tries to reduce its own workload over time by creating settled populations of CPEs that will stay on the optimal BTSs even after the CPE has been reset or power-recycled. In addition, it ‘learns’ from previous results of its actions over time by building up history of CPE connection state. This is used to avoid making poor decisions in the future which will cause more work for itself and more disruption for the CPE.

The overall activity of the load balancer application is controlled by a Gain Factor, which controls how quickly it should act to reduce imbalance between sectors over time.

### Load Balancing Problem Description

There are two viewpoints of the overall wireless broadband load balancer problem:
BTS-centric, which implies knowledge of relative equivalence between tuples of BTSs, so the destination of the load is known from the BTS viewpoint, and
CPE-centric, which is the least loaded given the list of known BTSs that a particular CPE can connect to.

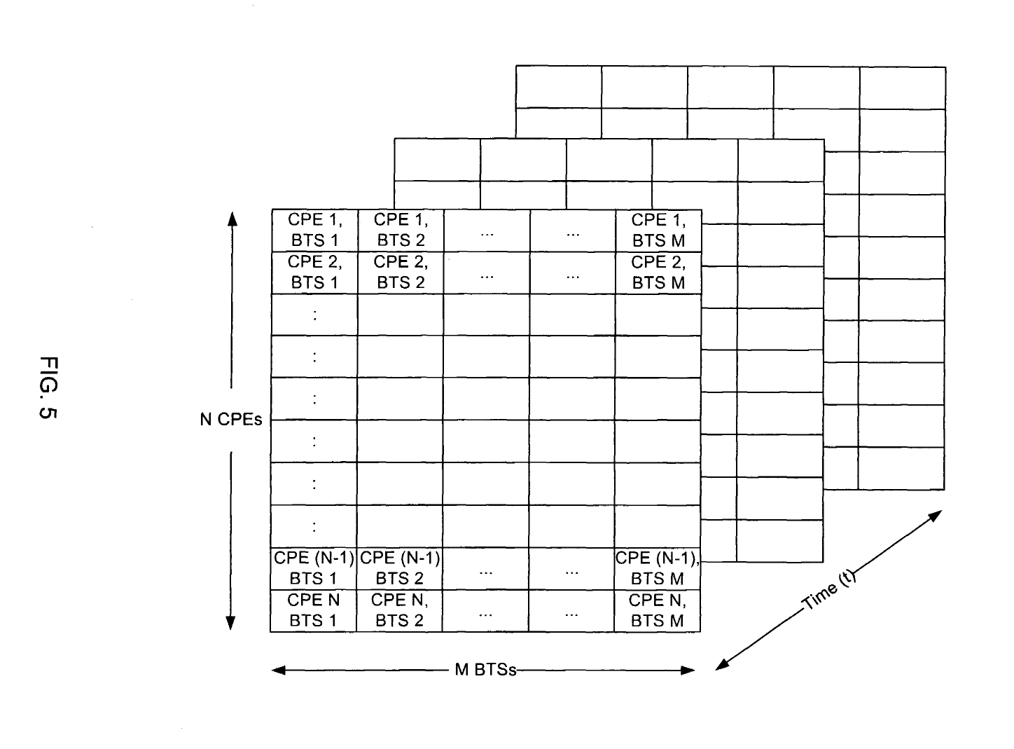

Theoretically, every CPE could see every BTS and thus the steady state solution becomes a two-order matrix of N CPEs×M BTSs in size; see FIG. 5. In practice, many ‘holes’ will exist in the matrix due to limitations in BTS coverage, making the matrix sparse and easier to solve. An entry of the matrix is represented as:

(CPEₙ,BTSₘ), n=1, . . . , N and m=1, . . . , M.

(CPEₙ,BTSₘ), has the value of one if the CPEₙ is within the coverage area of BTSₘ. The overall goal is to change the current steady-state situation between CPEs and BTSs over time according to network characteristics. As a result, a time variable must be introduced to the load matrix, resulting in a third-order polynomial matrix function of at least order two.

The current example uses a third order polynomial to allow for slow feedback rate of change, where the time factor can be differentiated to create a solvable version at any time (t) that describes the before-after network state. The resultant solution is represented with sets of multivariable equations for each individual BTS-CPE solution, and is solved using matrix algebra.

Each rule is described in terms on CPEs, BTSs, load state and time. In effect, within the load balancer a matrix is created, and then reduced to something more workable by eliminating any BTS-CPE combinations that cannot be viable, for example, based on recent CPE-BTS registration history. From the set of viable BTS-CPE combinations, an optimal ‘error state’ is derived, where error represents the deviation from perfect CPE-BTS harmony and equalized BTS load. Next, the matrix is solved for individual scenarios; each individual solution depends on individual boundary conditions defined by each CPE's connectivity history.

The overarching solution allows for multiple feedback that allow for both primary movements and secondary effects, and overlays can be pairs or arbitrarily large sets of equivalent tuples. For example any BTS may be ‘offloading’ to a less busy BTS, but the same BTS may also be receiving CPEs from a yet busier BTS above it, and there may be leakage of CPEs back to their original BTSs occurring. Further, due to the real-time nature of the system, these computations must be done rapidly across the board. From the perspective of an individual BTS, there are steady-state connections, as well as net inbound and outbound connection rates over time, which can be described using a differential equation, and it is these rates that the load balancer manages for overall stability.

### Load Balancer Operational and Move Modes

The load balancer has two main modes of operation:
Overlay mode, a BTS-centric mode, that only operates on BTSs that:
   are configured as direct capacity overlays
   are assumed to have similar RF coverage
   assumes BTS sectors are on the same physical tower site
   assumes equivalence at IP (DHCP) level for all BTS sectors
Overlay plus Adjacent Sector mode, a hybrid BTS/CPE-centric mode, that includes all Overlay capabilities, but also includes the ability to:
   balance between sectors that are adjacent in coverage on the same site (sectors that are not capacity overlays of each other)
   balance between sectors that are located on physically different sites (fully ubiquitous load balancer)

CPE migrations between two overlays are known as vertical migrations while CPE migrations between two adjacent sectors are known as horizontal migrations.

In addition to operational modes, the load balancer also supports three types of move modes:
Opportunistic move mode that choses CPEs that have been registered on a congested BTS in the past few minutes or seconds, with the aim of minimising end user outage
Forced move mode that choses CPEs that have been stable on a congested BTS for a long time (several hours for example) using a round robin algorithm to evenly distribute end-user interruptions. And,
Passive move mode, a process not driven by the load balancer, that happens with natural network CPE population dynamics.

When in passive mode, the load balancer analyses and selects in the background the observed moves that are considered beneficial, and uses Preferred BTS settings to prolong the state where possible; preferring CPEs away from busy BTSs and to quiet BTSs without forcibly moving them. This mode assumes that CPEs will eventually migrate away from busy BTSs or be reset and land where we want them to.

### Hysteresis

Hysteresis covers several related topics for controlling how the load balancer determines imbalance, and how it enters and exits activities to rectify it.

### BTS Load Calculations

BTS Load Calculations are performed using a weak classifier engine or a Combination of Weak Classifiers Engine (CWC) (240 of FIG. 2). The CWC engine takes multiple data feeds from EMS, which may or may not be highly correlated with each other, and present them in a format for quick analysis and decision making by the combination weighted sum voting engine. The input parameters are combined using linear combinatorial algebra to produce output parameters. The CWC engine may further have nonlinear processing to analyse time, frequency and locality based data trends simultaneously.

The CWC engine processes a number of BTS performance metrics and maps them to a load state level that represents how the load of a BTS. A Reject Ratio of a BTS is exponential function approximated by:

RR=kexp(0.08x),

where scaling factor k>1 and x may depend on a number of factors such code channel utilisation, RF power utilisation, parameters related to simultaneous sessions and ACC or TCC derived calculations.

### BTS Load State

The exponential function represents the inverse of typical saturation behaviour of a BTS. It is assumed that BTSs with low Reject Ratios are not congested. The load state level is a mapping of the Reject Ratio of a BTS to one of a number of discrete levels that represents the load of the BTS, that is:

Load State Levelε[0,N],

where N=number of predetermined load state levels. For example, the table below shows six load state levels, with level zero having the lowest RR and level six having the highest RR.

| Load State | 6 | 5 | 4 | 3 | 2 | 1 | 0 |
|---|---|---|---|---|---|---|---|
| Reject Ratio | >50% | >32% | >16% | >8% | >4% | >2% | <=2% |
| Allowed BW Move | 125000 | 115000 | 65000 | 50000 | 30000 | 0 | 0 |

Two BTSs are known as to be sufficiently different if the load state difference between them is more than a predetermined minimum difference. For example, if the minimum difference value is set to two, a source BTS (A) and a destination BTS (B) are sufficiently different if:

Sufficiently Different(A, B)=1, if Load State(A)−Load State(B)≧2,=0, otherwise.

This parameter is useful when making move decisions. The minimum difference in load level required between a destination BTS and a source BTS before the CPE can be moved to the destination. If the load level of the destination BTS is not at least this value or less than the source load level, the CPE cannot be moved to it. This means no CPEs will ever be sent to a BTS at load state 5 or higher.

### Hysteresis Entry and Exit Points

The hysteresis entry and exit points are set as follows:
Entry Point: BTSs are two or more load state apart, that is

Sufficiently Different(BTS_{A},BTS_{B})=1; and,
Exit Point: BTSs are equal to or less than |1| load state apart.

The reason for multiple hysteresis exit points is to provide a damping effect to help reduce overshoot as BTS load can jump several levels in a single 15-minute processing period (treated here as noise) and for consistency with the entry point.

Multiple exit points provide an average hysteresis correction of two to provide noise immunity.

### Predictive Look-Forward Sum

Predictive Look-forward Sum is Computed as
LFSum=½ (Latent Demand_{BTS A}−Latent Demand_{BTS B}), where:

$$Latent Demand = {\sum }_{n - 1}^{m} {CPE}_{n} .$$

PlanSpeedₙ, and
m=number of CPEs connected to a particular BTS.

During each cycle, the load balancer computes the matrix, then for BTS sibling solutions that meet the hysteresis entry criteria, the overall target bandwidth that is attempted to be moved at time t is computed as follows:

Target bandwidth to move(t)=LFSum(t)*Gain Factor(t).

### Gain Factor and Preemptive Polynomial Function

Gain Factor(t) is a function of time t to take into account the vastly differing temporal load variances on BTSs in various locations across the network. As peak hour load can change quickly, the rate of bandwidth redistribution will always lag behind the rate of inbound load bandwidth. Consequently, the net inbound load rate can exceed comfortable limits and expose BTSs to overload for a certain period until the load balancer is able to catch up.

To mitigate this time lag problem, the gain of the load balancer is varied over time to better adapt to load conditions and to give the load balancer a ‘head start’ with a phase delay to act more aggressively at the start of the peak hour period. This ‘head start’ is defined by a ‘Preemptive polynomial time offset’ parameter that defines the negative shift in time that the curve function should operate at compared to real time, to try to balance loads before the peaks actually occur. For example, if we want the load balancer to be more aggressive at 30 minutes before real peak known time at 10 pm, we would set this value to 30*60 or 1800.

The time-varying Gain Factor (t) is defined as:

Gain Factor(t)=Gain Factor*atⁿ+btⁿ⁻¹+ctⁿ⁻²+ . . . +mt+n.

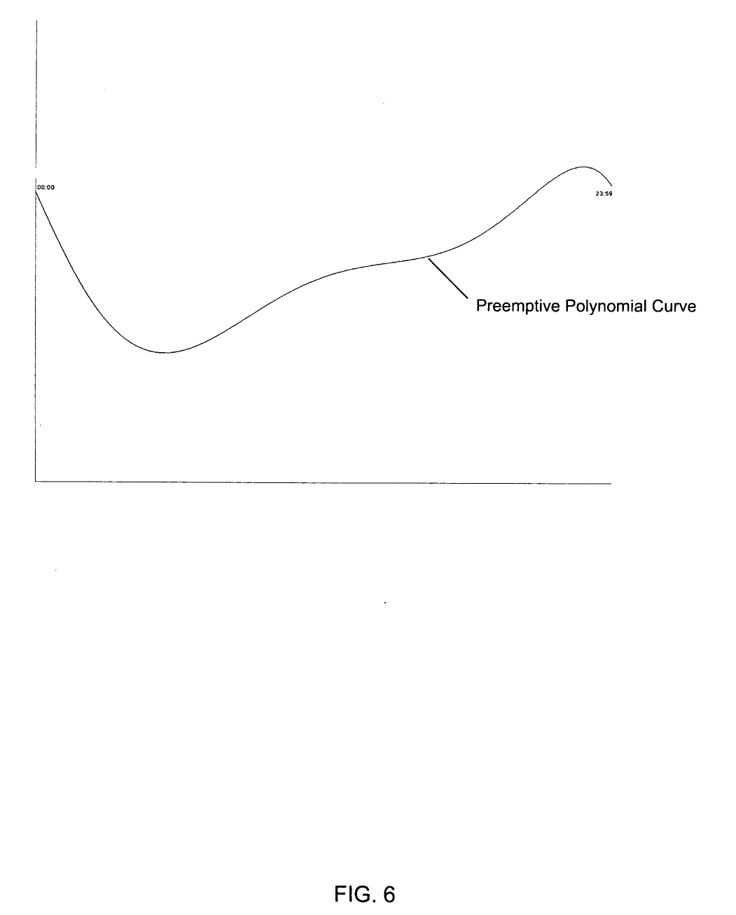

Preemptive polynomial coefficients (a,b,c, . . . , n) define the nth-order polynomial function that is used to boost the gain factor value for time-of-day aggressiveness for load balancing. An example of a preemptive polynomial curve is shown in FIG. 6, representing a time-varying network load that the Gain Factor should be adjusted to. This curve is normalised to a peak value of one.

### Gating

Gating is a term used to describe a counter applied to a number of CPEs that are allowed to be moved at each load balancer cycle between any pair of BTS siblings. This is an extremely important setting because in certain scenarios, it only takes a handful of moves to equalise load each cycle, and this setting ensures that this particular BTS sibling solution remains inactive until another classifier run is able to reassess load state. It is possible for the difference in bandwidth between sectors to be completed in approximately 15 minutes (ideal), or not complete all desired moves, or complete all of them within several minutes. Gating is known as ‘Maximum forced CPE moves per BTS’ and is particularly important in Overlay plus Adjacent Sector mode.

### BTS Health Checks

BTS Health checks cover several aspects of BTS responsiveness and will flag as a fault is one or more of the following conditions are satisfied:
BTS is not responding to SNMP requests for RFAdminStatus and MaxBTSPower IDs,
BTS Performance log timestamps are over one hour old,
BTS performance logs are missing,
BTS performance logs fail parsing against templates, and
BTS has a failed status in EMS.

### Load Balancing and CPE Moving

CPE moves are carried out using a sequence of Home BTS, Neighbouring BTS, Nomadic and Probe settings. To effect a move, the load balancer tells a CPE that the BTS it is attached to is no longer a valid BTS allowed to service this CPE, that the CPE is no longer nomadic, and then it probes the CPE. This action initiates a CPE-driven BTS search.

The CPE will then attach to BTSs it can see until it eventually ‘lands’ on the desired target BTS, at which time the load balancer sets the CPE to Nomadic-with-Preferred, with its Home BTS and Neighbouring BTS settings configured to prefer it to the new target BTS, and away from the original BTS. Several tracking tasks are then created to watch the CPE over time and update any statistics for reference when contemplating future moves.

The CPE does not need to be reset during any of these steps, and remains online. CPE moves between sectors vary in time duration—the shortest possible move is around 2 seconds, and the longest possible (failed) move attempt can take 2 minutes, but the average is around 10 seconds.

The accuracy of correct CPE to move is crucial to success. CPE Moving comprises the following steps:
Selecting a CPE to move by filtering CPE registration events on busy BTSs for Opportunistic Move mode; and cycling through all busy BTSs and selecting CPE candidates by via a round-robin algorithm for Forced Move mode.
Attempting to move the CPE selected.
Determining whether the move was successful.
And, updating affinity and statistics, and spawn CPE tracking tasks for future checkpoints.

### CPE Move

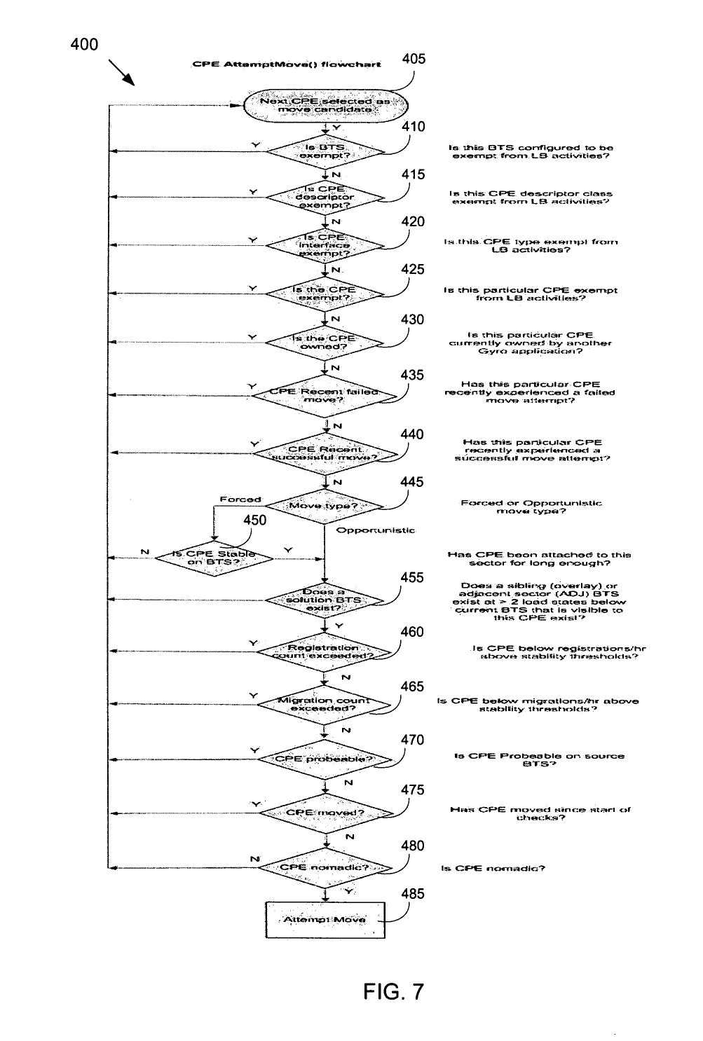

The step of attempting to move a CPE follows the steps illustrated in the flowchart in FIG. 7. For each selected CPE candidate to move to a new BTS, the algorithm performs a number of checks before moving the CPE; the algorithm:
First checks whether the BTS is configured to be exempted from load balancing activities in step 410.
If no to the previous check, it checks whether the descriptor class of the CPE is exempt from load balancing activities in step 415;
If no to the previous check, it checks whether the type of the CPE is exempt from load balancing activities in step 420.
If no to the previous check, it checks whether CPE is exempt from load balancing activities in step 425.
If no to the previous check, it checks whether the CPE is currently owned by another application running in the system in step 430.
If no to the previous check, it checks whether the CPE has recently experienced a failed move attempt in step 435.
If no to the previous check, it checks whether the CPE has recently experienced a successful move attempt in step 440.
If no to the previous check, it determines whether the move type is opportunistic or forced in step 445.
If the move type is forced, it checks whether the CPE has been attached to its current BTS or sector for long enough in step 450.
If yes to the above check or the move type is opportunistic, it checks whether the BTS has a sibling that is Sufficiently Different to itself in step 455.
If yes to the previous check, it checks whether the registration count of the CPE has exceeded a threshold in step 460.
If no to the previous check, it checks whether the CPE has exceeded a predetermined maximum migration count in step 465.
If no to the previous check, it checks whether the CPE is probeable in step 470.
If no to the previous check, it checks whether the CPE has been moved since the start of the algorithm in step 475.
If no to the previous check, it checks whether the CPE is nomadic in step 480.
If yes to the previous check, it finally moves CPE to the new BTS in step 485.

The system may effect connection changes by using the following process:
Telling a CPE that the BTS it is attached to is no longer a valid BTS allowed to service this CPE, and that the CPE is no longer nomadic.
Then it probes the CPE which action initiates a CPE-driven BTS search, and it will then attach to BTSs it can see until it eventually ‘lands’ on the desired target BTS.
At that time setting the CPE to Nomadic with Preferred, with its Home BTS and Neighbouring BTS settings configured to prefer it to the new target BTS, and away from the original BTS.
Finally several tracking tasks are then created to watch the CPE over time and update any statistics for reference when contemplating future moves.

### Load Balancing Threads

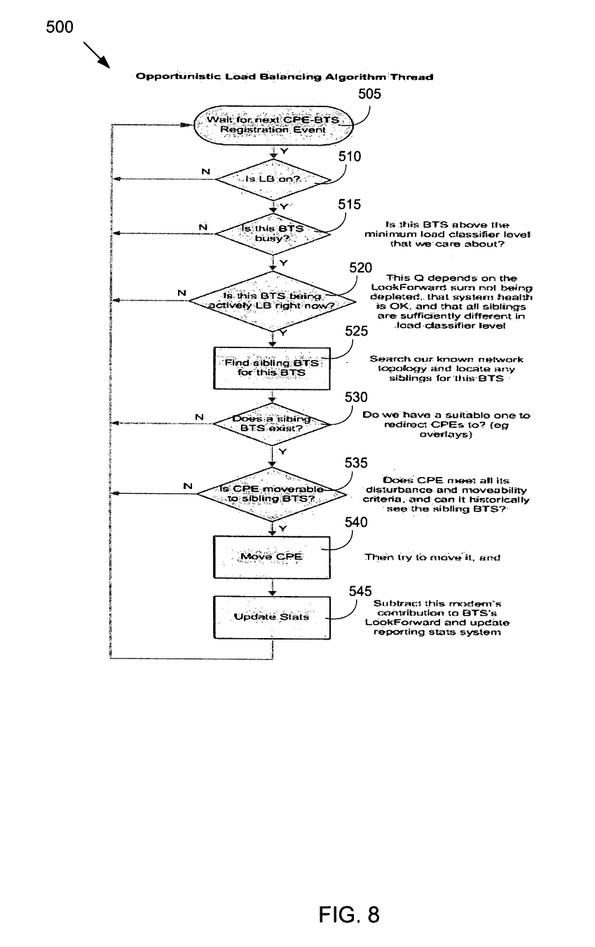

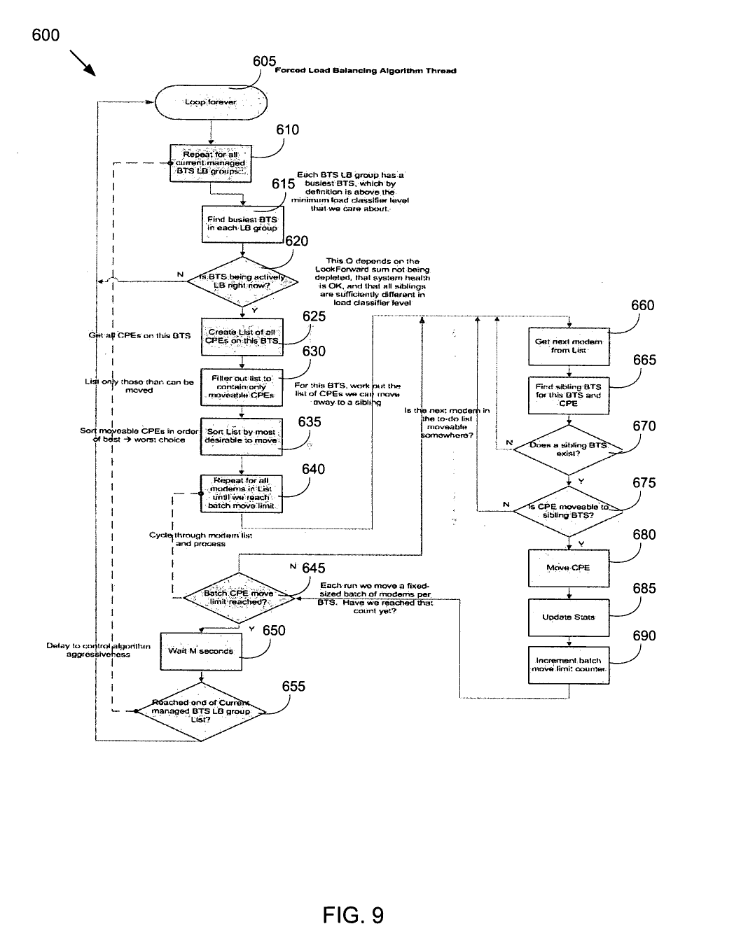

The opportunistic and forced load balancing algorithms are run on two separate but parallel threads. They will now be explained with reference to FIGS. 8 and 9 respectively.

### Opportunistic Load Balancing Thread

Referring to FIG. 8, the opportunistic load balancing thread runs in the background to wait for the next CPE-BTS registration event.

When an event occurs in step, the thread 500 performs several checks on whether:
Load balancing settings is selected for that particular BTS in step 510.
The BTS is busy, that is the BTS load state level is above a minimum load state level in step 515.
The BTS is being actively load-balanced in step 520, which depends on whether the predictive look-forward sum is not being depleted, a health checks on the BTS does not raise a fault, and all siblings of the BTS are sufficiently different.

If the BTS passes all these checks, the thread searches the network to locate the siblings for the BTS in step 525. If the current BTS has a sibling that is sufficiently different from it, the thread 500 then checks whether the CPE can be moved to the sibling BTS; steps 530 and 535. The movability of a CPE depends on a number of factors such as its signal interference characteristics and its historical affinity with the new BTS.

If the CPE can be moved, the thread 500 then attempts to move the CPE using the move attempt algorithm, AttemptMove( ) If the move is successful, various statistics related to the move will be updated.

### Forced Load Balancing Thread

Referring now to FIG. 9, the forced load balancing thread also runs in the background to redistribute loads from busy BTSs to other sufficiently different BTSs in the network.

The thread 600 runs actively for all managed BTSs load balancing groups. For each group of BTSs, the thread 600 finds the busiest BTS in the group whose load state level is higher than a minimum load state level; see steps 610 and 615.

Next, the thread checks whether the BTS is being actively load-balanced at the moment. The answer of such check depends on whether the predictive look-forward sum of the BTS is not being depleted, a health checks on the BTS does not raise a fault, and all siblings of the BTS are sufficiently different; see step 620.

If the BTS is being actively load-balanced, a list of all CPEs on this BTS is created in step 625. The moveable CPEs from this list is determined and then sorted according to their movability; see steps 630 and 635. The maximum number of CPEs that can be moved ‘by force’ during each cycle is defined as the gating of the BTS.

For each CPE in that filtered and sorted list, the thread finds the siblings of the BTS of the CPE; see steps 640 and 660 to 670. If the BTS has a sibling that is sufficiently different from itself, the thread then checks whether the CPE is movable to the sibling BTS in step 675.

If movable, the CPE is then moved from its source BTS to the current sibling BTS using the AttemptMove( ) algorithm discussed and when the move is successful, statistics related to the move will be updated; see steps 680 to 690.

The process of moving CPEs is repeated until the gating of the current BTS is reached. When this occurs, the thread is set to stop load balancing for a predetermined amount of time; see step 650. When this waiting period is up, the thread continues with a new load balancing BTS group.

The aggressiveness of the forced load balancing thread can be adjusted using the waiting period parameter. The shorter the waiting period after a batch of CPEs is moved, the more aggressive the algorithm is. In practice, the waiting period should be long enough to avoid oscillations between two busy states.

### Adjacent Sector Plus Overlay Mode

Adjacent sector load balancer is an enhancement to the existing overlay-only load balancing solution. It has ‘ADJ’ mode and ‘OVL’ mode, and the same data structures and the majority of algorithms are unchanged except for the introduction of a new function that takes into account BTS topology. ADJ load balancer can be configured with certain weights to effectively only act as overlay-only, or as ADJ only, or continuously between each of these extremes.

Instead of the look-forward sums applying to equivalent managed tuples of BTSs, the matrix for adjacent sector will apply to the BTSs themselves, and will be defined as either losses or gains for the sector irrespective of comparison to any other sector.

For adjacent sector, the situation changes and also becomes non-symmetrical. There are two ways ADJ mode in the load balancer includes adjacent sectors: biasing look-forward sums to apply downwards pressure on overall site load (by setting overall movement to be more disposed to reduce overall traffic than equalize it), and by influencing CPE decision-making. The look-forward sum table gains an extra row:

| Load State | 6 | 5 | 4 | 3 | 2 | 1 | 0 |
|---|---|---|---|---|---|---|---|
| Reject Ratio | >50% | >32% | >16% | >8% | >4% | >2% | 2% |
| Allowed BW Loss | 125000 | 115000 | 65000 | 50000 | 35000 | 10000 | 0 |
| Allowed BW Gain | 0 | 0 | 10000 | 35000 | 65000 | 115000 | 125000 |

### Adjacency Load Bias

Influencing CPE target BTS decision making is done by using a combination of topology and load state for all visible sectors, here known as Adjacency Load Bias. This parameter is determined as follows:

Weighting (BTS)+Load_state_offset (BTS) when Load State=0, or

Weighting (BTS)/Load_state (BTS) otherwise.

The preference of BTS targets depends on a set of weightings. For example, the Weightings can be set as follows to indicate the preference of BTS Targets:

Weighting(Overlay)=5 (most preferred),

Weighting(Adjacent Sector Same Site)=3.1, and

Weighting(Adjacent Sector Different Site)=2.1 (least preferred).

### Statistical Measures

### Affinity

Affinity is a simple statistical measurement of the propensity of a particular CPE of interest to stay attached to a particular BTS; that is, how ‘sticky’ the CPE is to its connecting BTS. A high affinity means the modem is likely to be stable on this BTS and remain a long time, and a low affinity means the mean connectivity lifetime with this CPE-BTS combination is low (and thus less likely to be a good target BTS solution). Affinity is a short term memory that helps the system make a more informed decision about the likely success and connection stability of a CPE move to a new BTS.

As there is no guarantee that the RF conditions, CPE placement or CPE location will stay static forever, the data also has a use-by date, implemented using a cache timeout mechanism. If the last known statistical information for a particular CPE-BTS combination is too old, that is triggering a cache timeout, the information will be discarded. Affinity information is gathered at every before-after CPE move opportunity, however is not applied to migrations that were not load balancer-driven (volumetrics are too high and the interpretation of the data would be unclear).

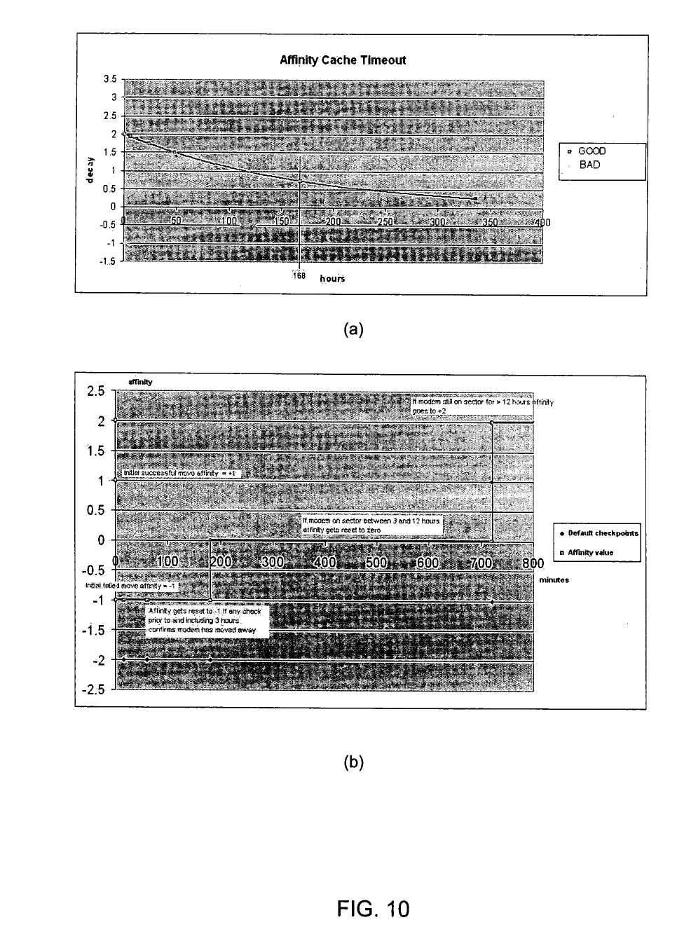

An example of a Affinity Cache Timeout plot is shown in FIG. 10A. General Information Theory says time-based knowledge decays weak-exponentially. After a successful CPE move, a sequence of related tracking tasks is automatically created to probe and record the CPE's current attached BTS at various checkpoints in time. This is configurable (as is the number of tracking tasks used). The default values may be set to:
Cache timeout: 7 days (168 hours)
Tracking periods: 15 mins, 1 hr, 3 hrs, 12 hrs
Penalty for moving away from target BTS in under 3 hours′=−1
Penalty for moving away from target BTS between 3 and 12 hours′=0
Bonus for remaining on target BTS for more than 12 hours′=+2

The load balancer may be extended to have a background air interface collector that caches S:N, ABS-PROC and SYN strength data collected in a slow rolling fashion for each newly discovered combinations of CPE-BTS. It will be based on the common air interface collection engine used in VCSR and will be used to enhance affinity decisions where fresh air interface data is available. Note that collection of this data is an expensive EMS operation, as it will simulate NavDiag and Beamform CORBA clients to obtain the data and this has finite impact on both EMS and BTS resources.

A plot of Affinity Values over Time is shown in FIG. 10B. If a CPE-BTS combination has no current affinity recorded, or an affinity of zero, it is not biased for or against the move, and other factors will dictate the overall decision. If it is negative, it is moved to the lowest end of the CPE move candidate queue. If it is positive, it is sorted towards the front (most likely candidates). Affinity is also updated upon every successful or failed move. The default values may be set to:
A failed move has a negative affinity set to −1
a successful move has a positive affinity set to +1
Any negative affinity associated moves in all but the most extreme cases will result in the move candidate failing the IsModemMovable( ) sanity check, and not occur.

### Perturbation

Perturbation is a term used to describe the movement of CPEs between sets of BTSs over time. Using the perturbation plots supplied it is possible to identify one of more of the following:
Normal load balancer activity.
Excessive to-from oscillations between overlay BTSs, or load balancer overshoot.
Bias between sectors (overall load balancer CPE movement always seems to be in one direction).
Magnitude of moves required to reach balance. And,
Groupings of movements between any arbitrary sets of BTSs (such as collateral load balancer effects on nearby BTSs, not just the managed overlay BTSs).

It is particularly important to observe system gain changes using perturbation. Sectors that vary greatly in load level over a 24-hour period (and correspondingly have high peak-to-average-throughout ratios) are more likely to show signs of excessive overshoot due to an overly aggressive gain factor.

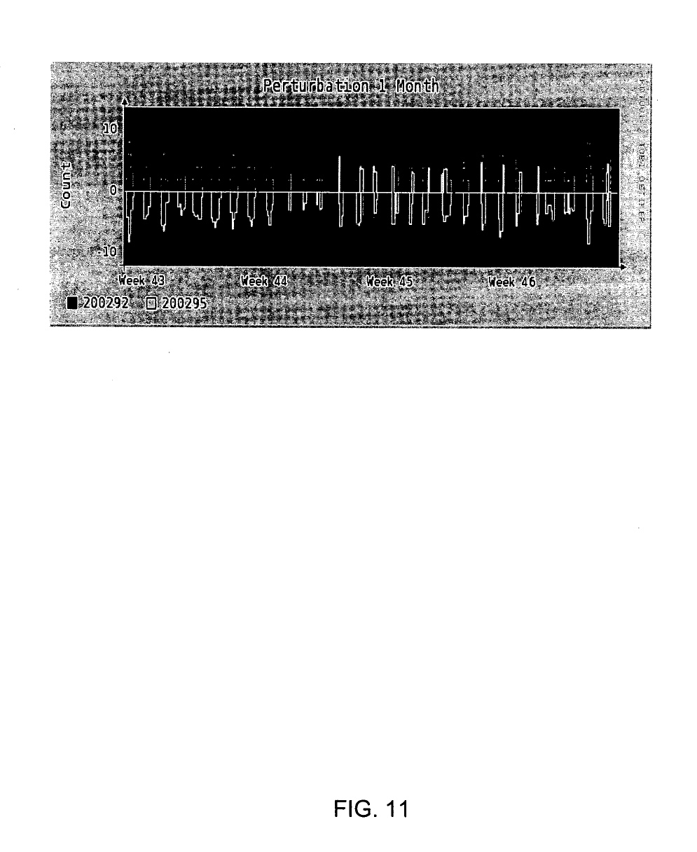

FIG. 11 is an example perturbation plot that shows load balancer-induced CPE movement over time. The vertical axis represents CPE count per 15 minutes. For example, we see prior to mid week 44 that BTS 200292 always gained modems, and BTS 200295 always lost the same number of modems. This indicates a predisposition for all CPEs in the area to always want to attach to BTS 200295, and not 200292. After mid week 44, a change to the site was made, and subsequent gains and losses per BTS were relatively equal (ie. normal).

The load balancer may be extended to have an adaptive damping mechanism per overlay tuple set to identify and cancel out secondary or smaller oscillations that may be present. This will be implemented as an individual gain factor per BTS tuple set, based on the overall gain factor and pre-emptive polynomial, with band pass filtering applied with an FIR filter to modify the resultant gain over time to counteract overshoot and reduce overall movement needed to achieve stable balance.

### Load Balancer Statistical Display

Referring back to FIG. 4, panel 312 on the load balancer user interface displays a summary of overall statistics for the current data collection cycle.

‘BTS statistics’ cover the count of BTSs in that are have the following status:
managed, that is those BTSs that are being actively load balanced;
new, that is new BTSs that were not in the managed list in the last run;
resolved, that is those present in the last run but not in current run;
still overloaded, that is those BTSs with load state over 1; and,
feedback gain, that is the overall system wide setting.

‘CPE Statistics’ describe CPE movement and cover:
the count of various move types and overall move success ratio;
the ratios at various intervals, as measured in this current cycle (CPEs that have returned back to original source BTS); and,
move counts by load balancer mode type.

‘Load Balancer Status’ shows current status of the load balancer engine, and how far into the current cycle it is. Each cycle lasts approximately 15 minutes.

Panel 314 of FIG. 4 shows three sets of plots with overall historical data, that is from all load balancer cycles prior to the current cycle. The plots are arranged in vertical columns on increasing timeframe up to yearly.

‘BTS Load State Count’ plots display the number of BTSs in each defined load state according to the weak classifier engine. ‘CPE moves and returns’ plots display the number of CPE moves, both forced and opportunistic, and their returns at different intervals. ‘Move Success Ratio’ plots display the success ratio of both forced and opportunistic moves.

Other features 316 on panel 314 allow users to monitor other important statistics.

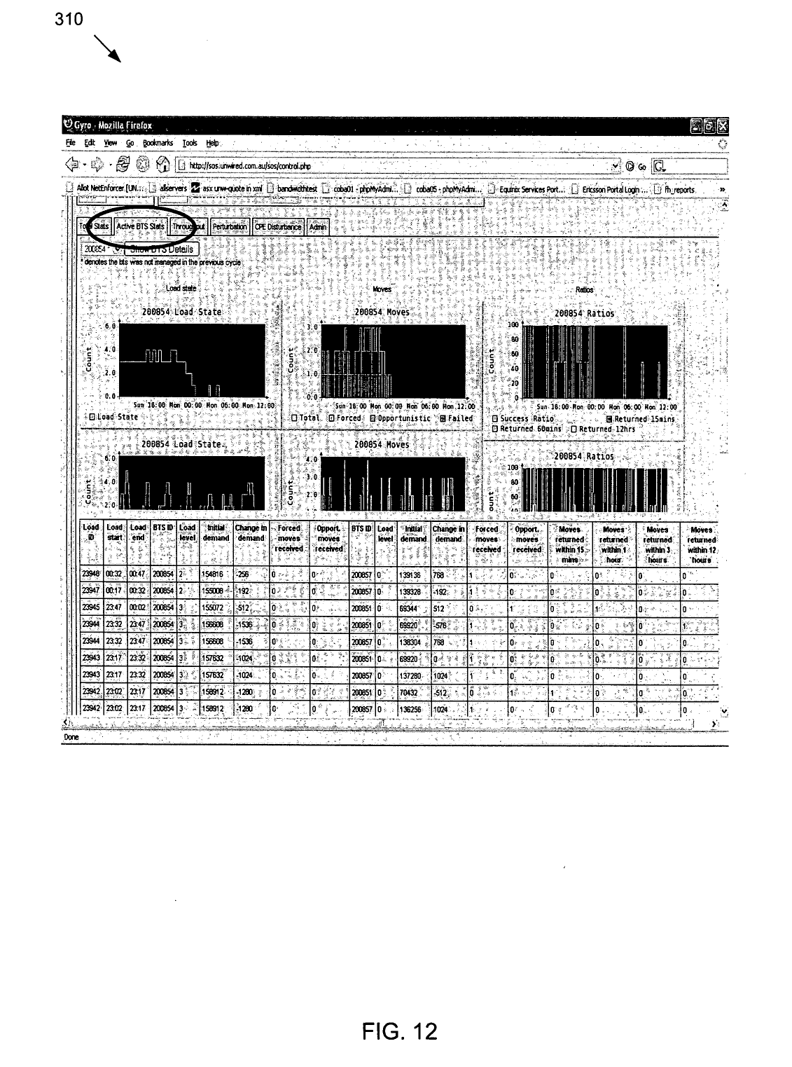

The active BTS statistics feature (see FIG. 12) shows identical data as the overall plots, with overlaid tabular data. Individual BTSs can be selected from a list of BTSs that were affected by the activity of the load balancer activity. For example, affected BTSs are managed BTSs that lost CPEs, gain new CPEs; or unmanaged BTSs who gained CPEs from or lost CPEs to another managed BTS at the time.

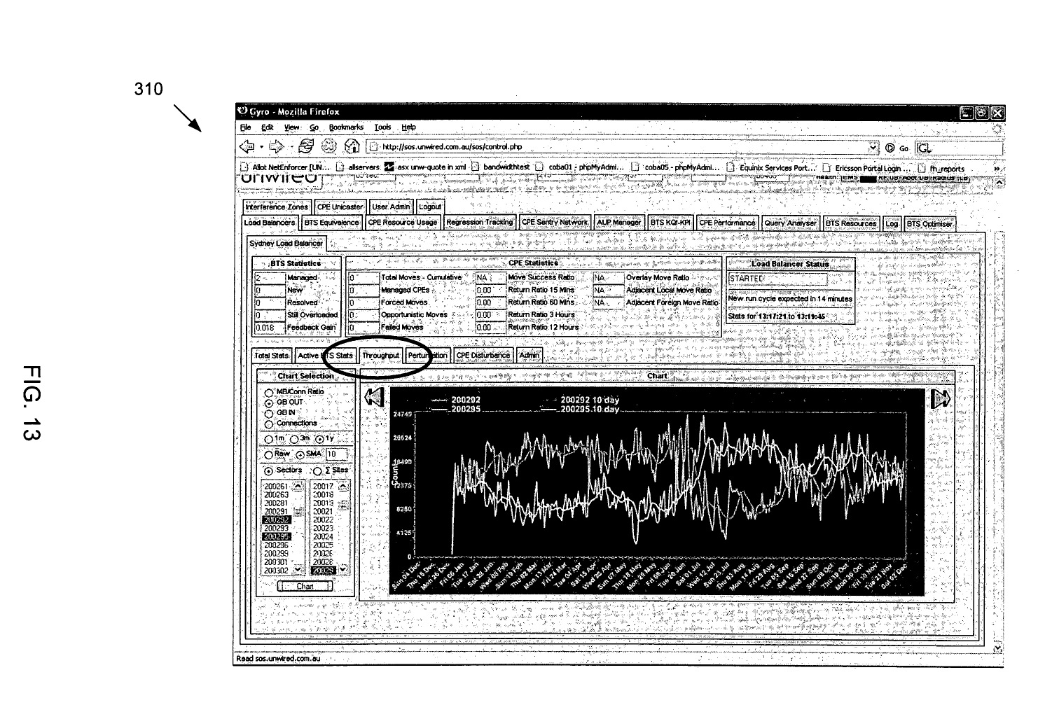

The throughput reporting feature (see FIG. 13) allows a user to use MRTG/DHCP data to plot traffic throughput and IP connectivity levels, as measured every 5-minute intervals. Users can select one of four data fields, over three periods of interest, and can select raw or Simple Moving Average (SMA) data with a selectable averaging period (in days). History of adjacent periods can be selected by following the arrows on the display.

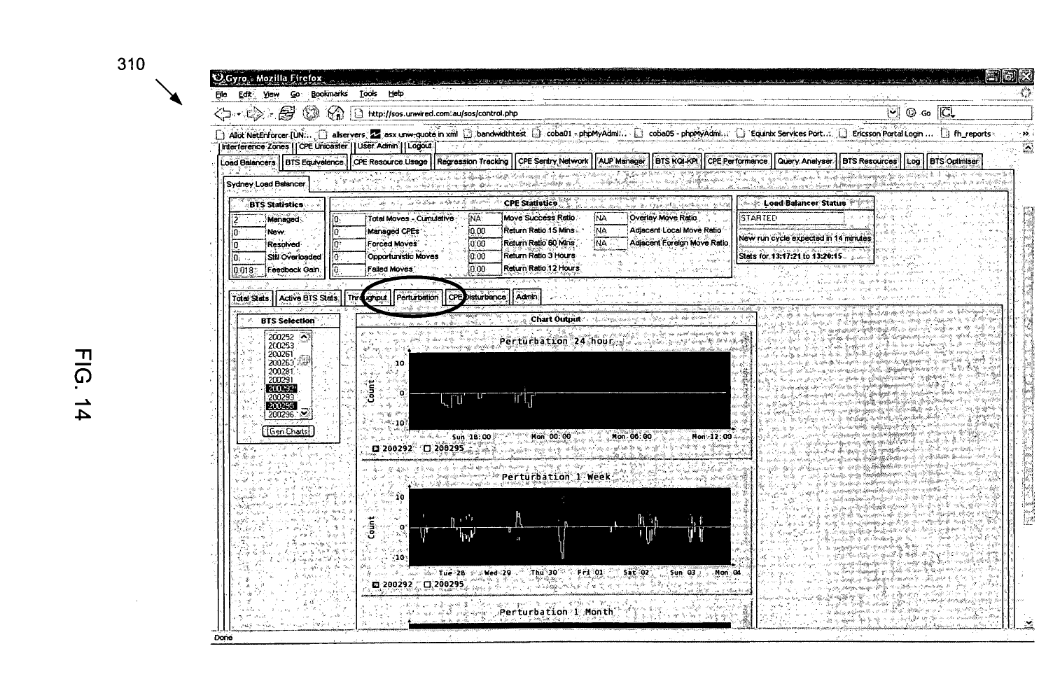

The pertubation monitoring feature (see FIG. 14) plots raw move counts between any groups of sectors of interest. The counts signify load balancer moves per 15 minute cycle.

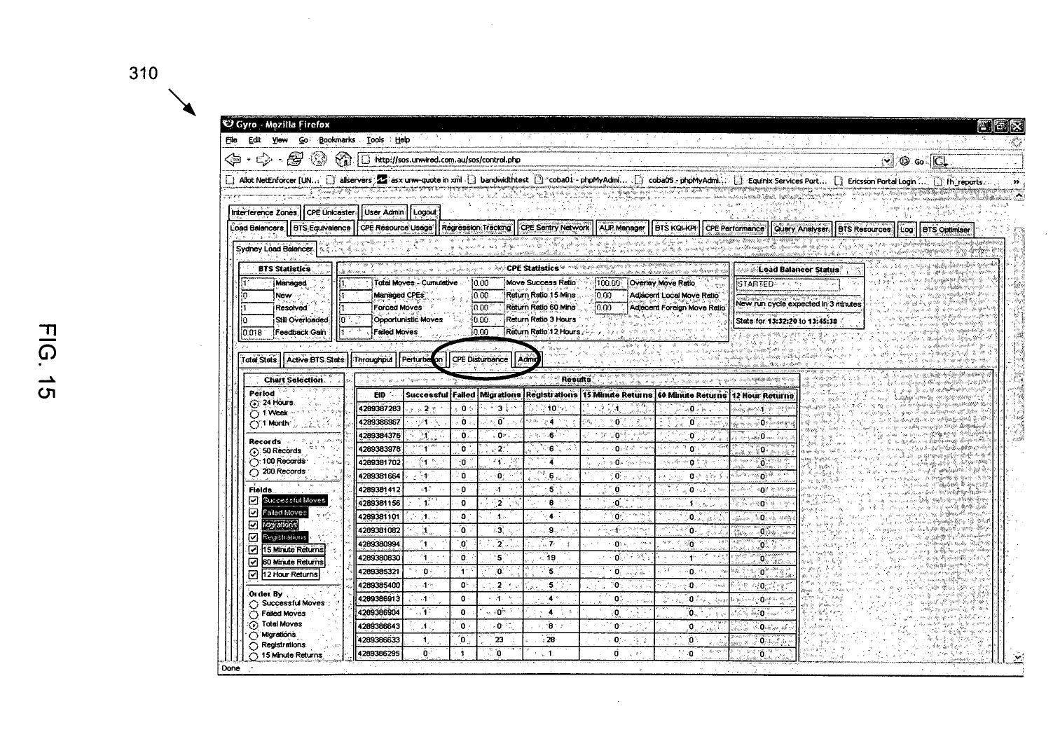

Using the CPE Disturbance monitoring feature (see FIG. 15), a user can select from a choice of periods, the number of records to return, various move success criteria, and sort order, and whether the results are to be presented graphically or in tabular format. This data is useful for load balancer CPE Stability tuning activities.

Finally, the ‘admin’ feature allows system administrators to configure a number of parameters affecting the operation of the load balancer.

### Hysteresis Setting Parameters

Maximum forced CPE moves per BTS or gating is the number of moves the forced mover can make on any BTS within a single classifier cycle.

Minimum eligible load level difference determines the minimum difference in load level required between a destination BTS and a source BTS before the CPE can be moved to the destination. If the load level of the destination BTS is not at least this value or less than the source load level, the CPE cannot be moved to it.

### Stability Index Setting Parameters

CPE move ownership period (in seconds) refers to the number of seconds that the load balancer ‘owns’ the CPE if it determines that it is a candidate for moving. When a CPE is ‘owned’ by an application it is not available to any other application until ownership is released.

Duplicate CPE move look-back period (in hours) refers to the number of hours that the load balancer will check back for an identical move to the one it is currently planning. If it finds an identical move, it will attempt a different move that is compatible with the CPEs current situation, or it will drop the attempt altogether if a suitable move cannot be found.

Failed CPE move grace period (in hours) refers to the number of hours the load balancer will look back at its move history to determine if the CPE failed a load balanced move. If the CPE failed any move within this time, it is not allowed to be moved again.

Successful CPE move grace period (in hours) determines the number of hours that the forced move algorithm looks back at the registrations of a CPE before it allows it to move off a particular BTS. If the CPE has registered with any other BTS within this time, it is not allowed to be moved by the forced mover. Note that this value does not affect the decisions being made by the opportunistic mover. Essentially it is used to determine CPEs that have been on a BTS for a long time.

Minimum forced stable period (in hours) determines the number of hours that the forced move algorithm looks back at the registrations of a CPE before it allows it to move off a particular BTS. If the CPE has registered with any other BTS within this time, it is not allowed to be moved by the forced mover. Note that this value does not affect the decisions being made by the opportunistic mover. Essentially it is used to determine CPEs that have been on a BTS for a long time.

Maximum hourly migration count refers to the maximum number of migrations a CPE is allowed to have within the last hour before it is allowed to be moved. CPEs with high migration counts are generally considered too unstable for the load balancer, which is why they are ignored.

Maximum hourly registration count refers to the maximum number of registrations a CPE is allowed to have within the last hour before it is allowed to be moved. CPEs with high registration counts are generally considered too unstable for the load balancer, which is why they are ignored.

Maximum weekly CPE move count is the maximum number of moves the load balancer is allowed to make on a single CPE per week.

BTS eligibility registration look-back (in hours) is the number of hours that the load balancer looks back at registration records to determine whether a CPE has registered at least once with a BTS. If it has registered at least once with the destination BTS within this time, it is allowed to move to the BTS, providing all other tests are passed. This is a basic check to see if the target BTS is likely to be visible to the CPE prior to moving it there.

Unstable BTS move look-back period (in hours) is the number of hours that the load balancer will look back through the CPE move tracking records looking for CPEs that fell off the BTS that they were sent to. This value is used in conjunction with the unstable drop off period and the unstable drop off count.

Unstable BTS move drop-off period (in hours) is the number of hours that the load balancer will use to measure the instability of a particular BTS for a particular CPE. If the CPE has fallen off the BTS that it was moved to within this period, the BTS may be considered unstable depending on the value of the unstable drop off count and the unstable look-back period.

Unstable BTS move maximum drop-offs is the number of drop-offs that a CPE can encounter with a particular BTS before it is considered unstable on that BTS given the conditions defined by unstable look-back period and the unstable drop-off period.

### Classifier Data Importer Setting Parameters

BTS statistics idle update delay (in seconds) determines the number of seconds that the BTS controller should wait before where there is no activity on the old objects before updating the statistics tables in the load balancer's database. Generally, all threads will finish what they're doing with the old data within seconds of the new data being loaded, so this value can be tuned depending on how busy the load balancer can get.

Registration update delay (in seconds) refers to the delay in seconds that the registration tracker in the load balancer will wait before re-polling the registration table in the load balancer's database. Generally this value should equal the rate at which the table is being populated with registration data.

Message queue inactive delay (in seconds) determines the number of seconds the queue distribution thread should wait if there is no activity on the queue before rechecking

Load state post import delay (in seconds) determines the number of seconds that the BTS controller waits after detecting a classifier data import before it looks to see if the classifier run has been completed. All combined classifiers need to have been run before the BTS controller will load their combine states into memory. This value should be worked out by deducting the BTS controller update delay from the difference in timing of the classifier import and the classifier runs.

Load state post import retry attempts refers to the number of attempts the load balancer will make after the import delay before it determines that the classifier runs are completed for the current import. If the number of attempts is exceeded, an error is raised and the load balancer's BTS controller will loop again. This value, in combination with the import delay should be tuned so that no errors are produced.

Load state post import retry delay (in seconds) sets the delay between retry attempts if the load balancer's BTS controller is in its retry loop trying to load the newest load state values.

Load state scan delay (in seconds) refers to the number of seconds that the load balancer's BTS controller sleeps each cycle before checking whether a new classifier data import has occurred. The smaller the value, the more responsive the load balancer is at loading the BTS load states.

### System Setting Parameters

Force connection on unseen overlays, when selected, will force the load balancer to try a move to an overlay even if the CPE has never registered on that overlay.

Restricted BTS is the list of BTSs that will be allowed to be load balanced when the load balancer is in restricted BTS mode.

Restricted CPE is the list of CPEs that will be allowed to be load balanced when the load balancer is in restricted CPE mode.

Gain polynomial coefficients is a sequence of numbers that define the nth-order polynomial function that is used to boost the gain factor value for time-of-day aggressiveness for load balancing. This equation defines a curve that describes peak load times throughout the day from t=00:00 to t=23:59, and using this curve the load balancer can act with increased or decreased agility as required to keep up.

Preemptive polynomial time offset defines (in seconds) the negative shift in time that the curve function should operate at compared to real time, to try to balance loads before the peaks actually occur. For example, if we want the load balancer to preemptively be more aggressive at 30 minutes before real peak known time at 10 pm, we would set this value to 30*60 or 1800.

Gain factor determines how aggressively the load balancer moves modems as they register on the network or are assessed by forced move algorithm to need moving. This value can range from 0 to 1 where 0 effectively turns off all moves and 1 is the most aggressive. When the value is 1, it will try to equalise the entire load mismatch between all BTSs within a 15 minute period. The lower the value the more slowly BTSs get balanced. If this number is too high, it can cause oscillation between BTSs. Nominal value: 0.05.

Gain load state demands is the list of load state demand allowance values that are added to each of the destination BTSs being managed by the load balancer during CPE moves. These values refer to the amount of bandwidth that a BTS is allowed to take given a certain load state. The first value in the list refers to the amount of bandwidth that the destination BTS is allowed to take if it has a load state of 0, the second if it has a load state of 1, and so on. These values are in kbps, and is a tunable parameter.

Loss load state demands is the list of load state demand allowance values that are removed from each of the source BTSs being managed by the load balancer during CPE moves. These values refer to the amount of bandwidth that a BTS is allowed to loose given a certain load state. The first value in the list refers to the amount of bandwidth that the source BTS is allowed to loose if it has a load state of 0, the second if it has a load state of 1, and so on. These values are in kbps, and is a tuneable parameter.

CPE interface identification values refer to the interface identification numbers of the CPEs.

CPE descriptor indexes refer to the descriptor index values that the load balancer will process.

Statistics notification emails list contains zero or more email addresses to which the load balancer 15 minute statistics are sent. If the load balancer is silent for a given period, no statistics are sent.

### Modes Setting Parameters

Read only, when checked, puts the load balancer in to read only mode. While in this mode, it will still perform all checks, issue internal messages and record statistics, but it will not perform CPE moves.

Overlay only mode, when selected, restricts load balancer behaviour to only dedicated capacity overlays. It will not use neighbouring or adjacent sectors in load balancing solutions.

Same site mode, when selected, restricts adjacent mode load balancer behaviour to moves within sectors on the same site only, that is, only to overlays and adjacent sectors. Foreign site adjacent sector moves are blocked.

Forced mode, when checked, turns on the forced mover within the load balancer. The forced mover is a thread that scans for stable CPEs on each BTS and tries to move them to BTSs that are both compatible and on a lower load state than the one that they are currently on.

Opportunistic mode, when checked, turns on the opportunistic mover within the load balancer. The opportunistic mover is a thread that listens to registration events as they come into the load balancer's database through registration import scripts. As registrations are captured, the CPE is tested for eligibility of being moved to a compatible yet less loaded BTS than the one they are currently on. If the test passes, an attempt is made to move the CPE to the better BTS.

Restricted BTS, when selected, will turn the load balancer into restricted BTS mode. While in this mode, the load balancer will balance only those BTSs in the restricted BTS list.

Restricted CPE, when selected, will turn the load balancer into restricted CPE mode. While in this mode, the load balancer will balance only those CPEs in the restricted CPE list.

### Affinity Setting Parameters

Cache timeout (in hours) is the number of hours that the CPE affinity data remains active for. Affinity records older than this number of hours are ignored by the load balancer.

Successful move destination affinity is the affinity value that the CPE/destination BTS acquires if the initial move is successful.

Failed move destination affinity is the affinity value that the CPE/destination BTS acquires if the initial move fails.

Successful move source affinity is the affinity value that the CPE source BTS acquires if the initial move is successful.

CPE move tracking periods (in seconds) refer to the periods after each CPE move that the load balancer should check that the move is still stable. If the CPE is still on the BTS that it was moved to, the tracking continues until all tracking periods are exhausted. These periods are in seconds. Tracking events are stored in the CPE tracking table in the load balancer's database.

CPE move penalty corresponds with the ‘CPE move tracking period’. The affinity values in this list refer to the affinity that the CPE/destination BTS acquires if the CPE falls of the BTS within the corresponding tracking period. If the CPE is still on the destination BTS at the time that the last tracking event occurs, it acquires the highest affinity.

Maximum prefer to source period (in seconds) refers to the number of seconds, within which time if the CPE falls off the destination BTS and returns back the original source BTS that it is preferred to that original source BTS using the Nomadic-Preferred method (Navini-specific).

### Adjacency Load Bias Setting Parameters

Capacity overlay load offset sets the initial offset (at load state 0) for computation of the BTS bias for BTS overlays. BTS Bias (at load state 0) is set to initial offset plus weighting.

Adjacent sector local site load offset sets the initial offset at load state 0 for computation of the BTS bias for adjacent BTS sectors on the same site. BTS Bias (at load state 0) is set to initial offset plus weighting.

Adjacent sector foreign site load offset sets the initial offset at load state 0 for computation of the BTS bias for adjacent BTS sectors on foreign sites. BTS Bias (at load state 0) is set to initial offset plus weighting.

Capacity overlay weighting sets the weighting at any load state for computation of the BTS bias for BTS overlays. BTS Bias is set to weighting divided by load state.

Adjacent sector local site weighting sets the weighting at any load state for computation of the BTS bias for adjacent BTS sectors on the same site. BTS Bias is set to weighting divided by load state.

Adjacent sector foreign site weighting sets the weighting at any load state for computation of the BTS bias for adjacent BTS sectors on foreign sites. BTS Bias is set to weighting divided by load state.

### BTS Equivalence 315

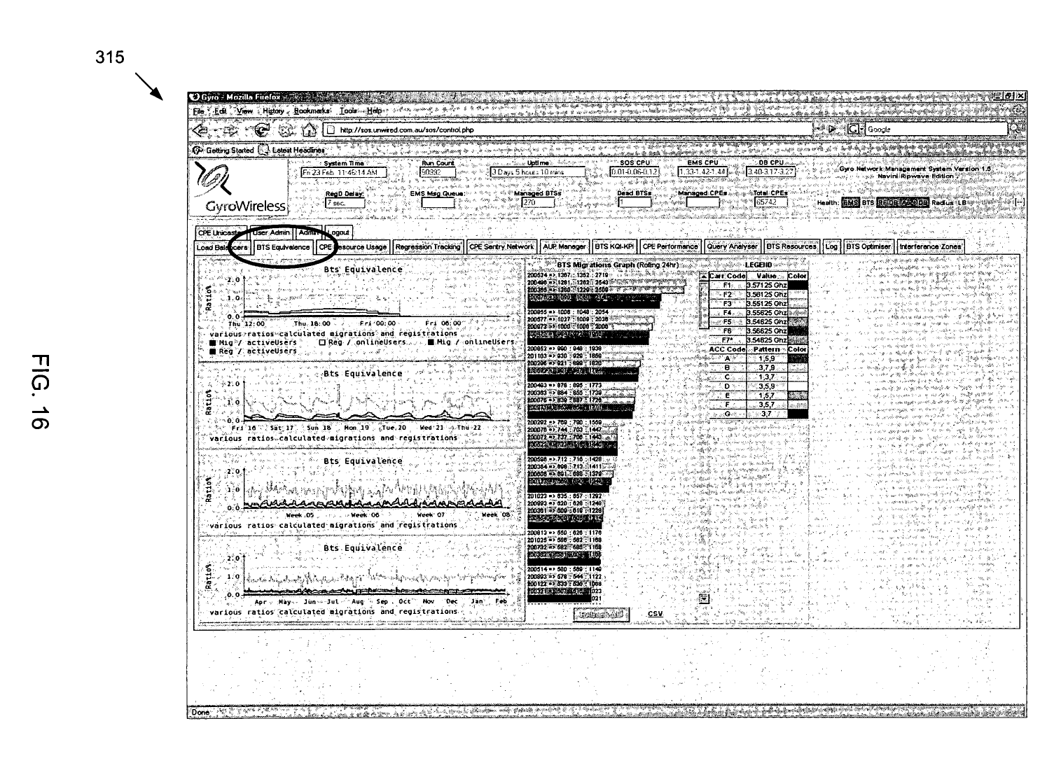

The BTS Equivalence 315 feature of FIGS. 3 and 16 collates event-based connectivity statistics from individual CPEs across the network, and then aggregates it by base station. By analysing the azimuth, location and other settings of BTSs, it detects those that are likely to be interfering or essentially fighting over the same set of modems, and can track migration of customers across the network as a function of time.

This data collected can be used to assess overall network coverage quality and detect interference. Network engineers may use the data displayed to:
detect areas of interference by comparing migrations between sectors on the same base frequency;
detect relative overlap of adjacent sectors on different frequencies;
compare the location of CPEs to expected base station coverage to validate the theoretical map coverage;
identify CPEs pin-ponging between sectors, which may provide clues to new RF clutter in the environment;
locate CPEs that may have begun to fail and may be acting out of specification; and
determine average connections and migrations between base stations per day to quantify overall network connection stability for new software downloads.

### CPE Resource Usage 320

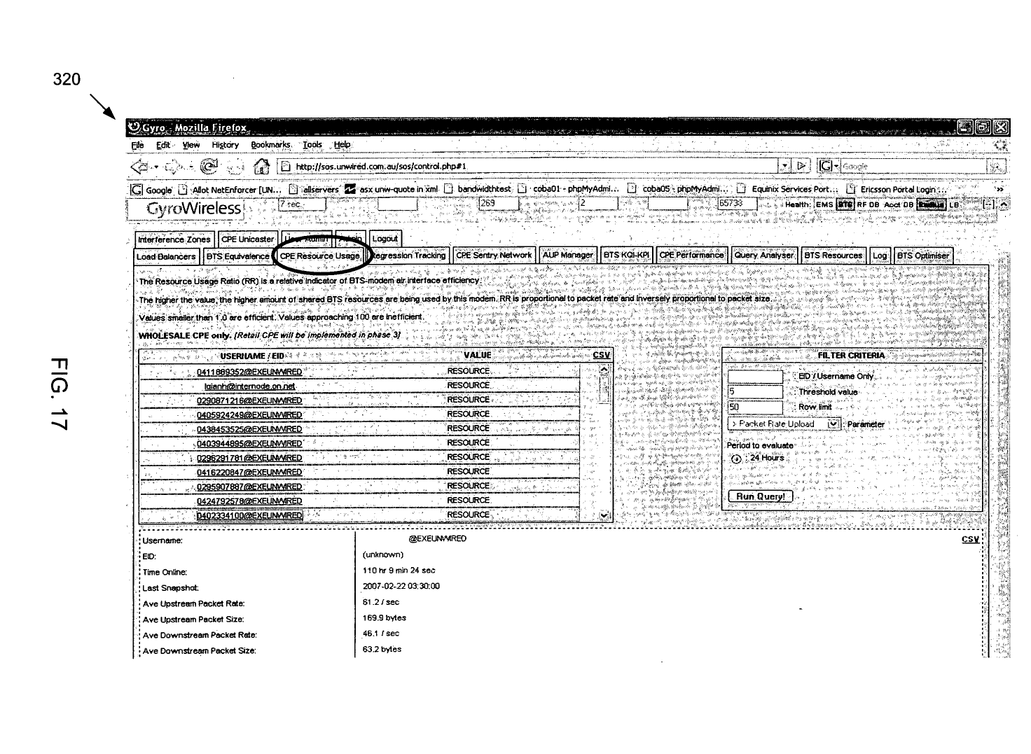

Every network has voracious consumers whose CPEs consume disproportionate resources. They may be hosting file sharing services, or their computers may be infected with viruses. The CPE Resource Usage 320 feature FIGS. 3 and 17 detects greedy CPEs in near real-time and determines if their BTS is becoming congested.

The system computes a resource usage ratio to assess the air interface efficiency between a CPE and a BTS. The higher the ratio, the higher amount the resource usage of the CPE, which is proportional to packet rate and inversely proportional to packet size. For example, values smaller than 1 are efficient and values approaching 100 are not.

If greedy behaviour is detected, the invention may apply a set of business rules to deal with the situation, such as changing the priority of the CPE traffic via traffic shaping, or moving the CPE to a less busy base station. More punitive sanctions can be applied if the customer consistently breaches the network operator's acceptable usage policy (AUP).

For example, a virus-infected CPE has the tendency to download small amount of packets over a long period of time without the knowledge of its user. A network administrator or customer service representative may either stop the CPE from continuing this activity or call the user to solve the problem.

### Regression Tracking 325

Network operators routinely add new base stations, change base station configurations, rollout new software and download firmware upgrades to customer CPEs. These changes can have unpredictable impacts. While the performance of the network as a whole might be improved, individual CPEs or base stations may suffer degraded performance.

The Regression Tracking 325 feature of FIG. 3 acts as an interface for network engineers to perform a before-and-after analysis of the network. Before a change is made, engineers may direct the feature to gather data on those BTSs to which the change will be applied and, concomitantly, the associated CPEs. They can specify the period of data collection.

After the change, this feature continues to collect data, allowing engineers to compare before and after states, examining BTS operating statistics, performance metrics and CPE connectivity data. This analysis is especially useful for finding customers who have dropped off the network since the change.

### CPE Sentry Network 330

CPE Sentry Network 330 of FIG. 3 allows a part of the network, from an individual CPE to a while sector, to be probed for troubleshooting. As shown in FIG. 1, a CPE may also be a canary that has been deployed to collect information from a customer's point of view and to run tests when probed by the system 200.

These canaries 140 are programmed to receive commands from the system 200 to run a series of upload and download speed tests, packet loss and latency etc as a normal user would. Each canary 140 may be moved between all sectors visible to the canary at its location, and thus can analyse the performance of multiple BTSs. In addition, these canaries are configurable to be exempt from load balancing activities.

The CPEs being probed are known as sentinels. The system 200 will first go through a list of sentinels and sends each of them a PROBE command to ensure that it is online. If a sentinel is online, the system 200 will send test commands to the sentinel to test, for example, the speed of the BTS it is connected to.

When the test completes, the sentinel will send the results to the system 200 via a HTTP post. The system 200 may then send more test commands to the sentinel to continue testing the current BTS. Next, the sentinel may be disconnected from its current BTS and moved to a new BTS visible to the sentinel to test another BTS.

### Acceptable Usage Policy (AUP) Manager 335

The goal of AUP Manager 335 is not to act as an Internet policeman at a visible business sense to customers, but to act on detected threats to RF access layer efficiency at that level, and operate in the background wherever possible. It operates

The AUP manager acts as follows. Using raw IP-level (Layer 3 Internet) traffic data, the manager routinely identifies CPEs whose IP level traffic statistics appear to violate AUP guidelines. This should result in a small, manageable exception-based list for further processing and action.

The AUP manager also uses the narrowed-down list of pre-qualified CPEs obtained above to find CPEs that are connected to a busy BTS. This feature exploits the system's cross-layer ability to extract air interface data (that is, Layer 1 and 2) to obtain statistics on the air interface usage for these CPEs.

Further, the AUP manager uses a combination of predetermined business rules to determine if only AUP violators on BTSs already under stress, or all users who match a certain profile irrespective of where they are. Users are given a choice to manage these users in a disruptive or non-disruptive manner to the end customer; again this will be selectable.

From then, one or more of the following actions can be taken:
Changing the user's CPE speed descriptor to have a lower minimum resource allocation.
Dropping the CPE to a lower descriptor class of service until the unwanted activity ceases.
Sending messages to the user via email, website message or other mechanism
Arranging the load balanced CPE list to place them as the first choice of being moved to a new BTS, and relax rules for these users only about how many times they are allowed to be disturbed over time.
Disabling the CPE.
Having multiple steps of any combination and repetition thresholds of the above.

### BTS KQI-KPI 340

The BTS KQI-KPI 340 feature of FIG. 3 combines three important factors as key quality and performance indicators:
Revenue measured by the plan revenue of all attached CPEs pro-rated to time on each base station in dollars per hour.
Base station stress level measured by the usage of key scarce resources, such as power, channels and beam-forms.
And, customer service metrics measured by speed and connectivity stability.

This feature combines this data with cross-layer information to locate BTSs, and therefore CPEs, that are in the high-risk category for poor quality of service in terms of speed and connection quality.

This feature provides a systematic, consistent and quantitative methodology that describes base station performance in terms of revenue, customer satisfaction and BTS efficiency. It also acts as a tool to calculate, report and detect these changes and outliers

### CPE Performance Monitor 345

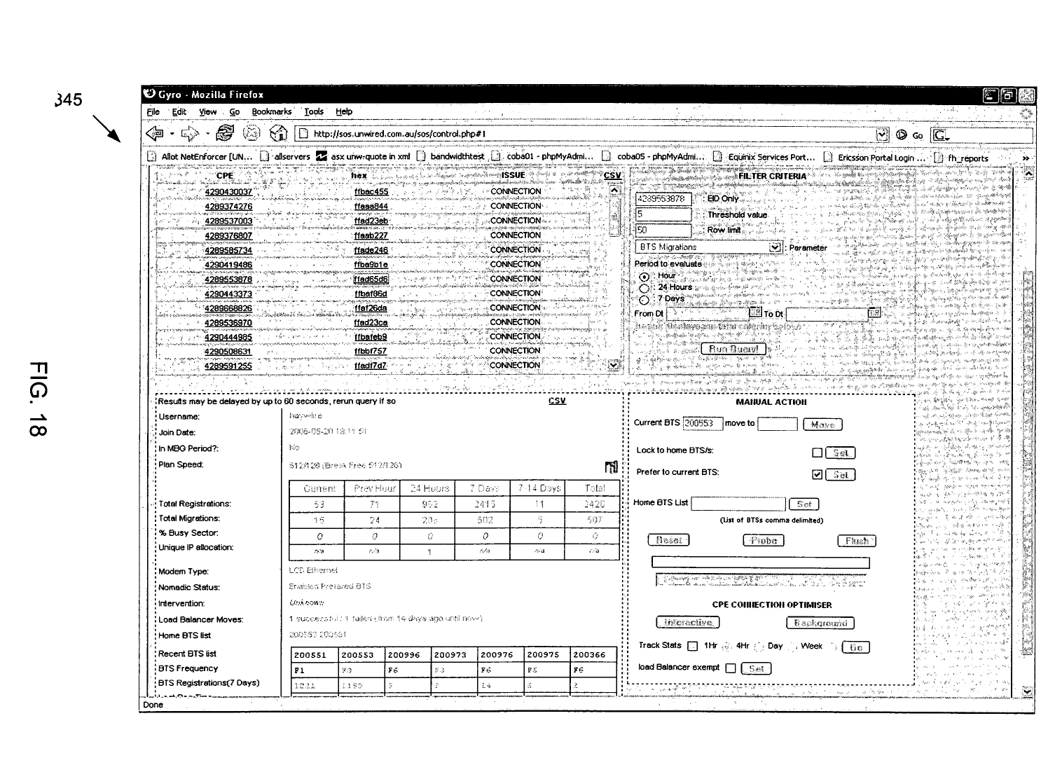

Referring to FIG. 18, this feature allows network engineers to examine detailed historical statistics about CPE connectivity. Individual CPEs can be examined, or troublesome groups of CPEs whose service connectivity falls below some specified standard. For example, staff can search for CPEs with dozens of registrations a day, or multiple migrations.

Data may be displayed in tabular, comma separated values (csv) and graphical formats. This feature also retrieves the historical list of base stations accessed by the CPE(s), together with the BTS basic frequency data and congestion states at times of interest to the CPE(s).

This feature allows customer care staff to diagnose the root cause of service-quality issues, such as congestion at a BTS when a customer complains about download speeds or unstable connectivity. The problem may be due to the interference between two BTSs that are on the same base frequency.

Using the data presented by this feature, help desk staff may instruct the CPE to connect to base stations in a specified order of preference, move CPEs between base stations, or exempt them from automatic load balancing. A CPE may also be tracked for a predetermined period, obtaining reports on improvements or deterioration to service.

### Query Analyser 350

Query Analyser 350 of FIG. 3 is a general purpose tool to interrogate the extended historical data stored by the invention and is specifically intended for the examination of data over long time periods.

It is configurable to retrieve data relating to a number of predetermined queries that are of interest to network engineers, such as:
‘How many CPEs are locked into this BTS?’; and
‘What is the complete connection history for the past four months for this CPE?’.

Users can set various search criteria. Results are returned in tabular or csv format which can then be presented graphically. This feature allows a network administrator or help desk personnel to ask arbitrary questions about many aspects of the network to, for example, detect problems or answer user's questions.

### BTS Resource 355

As shown in FIG. 18, the BTS Resource 355 feature provides a window into the weak classifier system of the invention. This feature displays a flexible, sortable tabular display of data showing the state of each base station and shows snapshots of data from many discrete sources at once, including RF traffic measurement and power usage.

This powerful tool allows operators to look at across-the-board instantaneous snapshot data for all base station, and historical trend data for any combination of data sources and base stations of interest. It provides a snapshot of the power usage, code channels, traffic levels and various other aspects of a BTS performance. This data can then be used to find any particular bottleneck and to tune BTS performance.

In addition to current performance data, this feature also provides an interface to monitor and analyse time-varying BTS performance data. Historical data from one or more base stations can be plotted graphically over several time frames. The data can be downloaded into a csv spreadsheet that allows engineers to track trends and find outlier base stations.

The tool also shows in real-time those BTSs that are being actively balanced by the load balancer engine 310.

### BTS Optimiser 360

BTS optimisation is necessary because of the dynamic operating environment of a BTS, which depends on a number of dynamic operating parameters such as:
RF coverage;
user profiles,
user patterns,
loading and
other physical characteristics.

BTS Optimiser 360 tunes BTS settings dynamically in real-time to adapt to the operating parameters of the BTS. BTS optimisation comprises the following steps:
reading BTS performance data from the classifier engine,
inferring BTS optimal settings using the weak classifier engine 240 (see FIG. 2) for a variety of operating conditions,
computing an optimal settings for each BTS from known relationships and using predefined rules, and
instructing other engines to act on the optimal settings computed.

The BTS performance data may be instantaneous, medium-term, or trend data from the classifier engine and provide another engine with instructions to act on this data. Examples of operating conditions are high load, low load, high in RF power draw but low in code channel usage and vice versa.

This feature allows network engineers to tune BTS settings, and possibly those for other network performance appliances such as traffic shapers, on-the-fly to best suit the conditions as they are detected. An individual BTS may be optimised according to the dynamic factors discussed above.

### Interference Zones 365

Interference Zones 365 of FIG. 3 uses existing CPE and BTS registration data and location-based services to determine the actual coverage of the BTSs. The statistical data on CPE migrations between BTSs is useful in identifying areas where interference is a likely causal factor.

Combining statistical data on CPE migrations between BTSs with location-based services and overlaying it over a coverage map provides a powerful means for identifying interference. This feature combines a coverage map, known co-ordinates of BTS locations, azimuths of sectors, beam-form and triangulation data to pinpoint CPE locations. This data is then correlated with BTSs registration events to detect possible trouble spots.

This feature also provides the following capabilities:
Validation of coverage area per BTS with real CPE data.
Identification of sudden changes to registration and migration events in certain areas, indicating a change in clutter (eg a newly erected building interferes with planned scatter and coverage predictions).
Direct comparison of registration events of sectors on the same base frequency to identify areas of N=1 interference.
Identification of other antenna re-tilt and re-azimuth changes that may improve overall performance without additional CAPEX layout.
Selective sector-versus sector, and sector-over time comparisons.
Combine with known area-based churn data, and using this to predict similar churn rate in other areas and be able to identify and manage the underlying causes.

### CPE Unicaster 370

CPE Unicaster of FIG. 3 detects CPEs that have missed a broadcast software upgrade and resends the upgrade to these CPEs via a unicast. Network operators periodically download new firmware to their customers' CPEs. Rather than burden the network with a mass broadcast, the invention allows operators unicast and broadcast selectively.

At registration, or any other definable time, each CPE is interrogated about the state of its firmware. If needed, new firmware is downloaded just to that particular CPE. The level of unicasting is controlled so that network and base station loads are not impacted.

### Supported RF Technologies

The invention operates with any WiMAX-compatible 802.16d or 802.16e access network. It may also operate with some pre-WiMAX proprietary networks, and any 3G technology such as W-CDMA, UMTS (3GSM), FOMA, TD-CDMA/UMTS-TDD, 1×EV-DO/IS-856, TD-SCDMA, GAN/UMA, HSDPA, HSUPA or HSOPA.

This invention is also independent of the vendor infrastructure of a wireless broadband network. By running independently of core system functions, it may collect and decipher information on every aspect of the network.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A wireless broadband network management system, comprising:
a data collection engine to collect data concerning traffic levels through the network base transceiver stations (BTSs), and the BTSs to which particular customer premise equipment (CPE) can connect: and
a processor to correlate the data collected; to monitor overall network performance; to aggregate performance of one or more CPES and BTSs; to detect underperforming BTSs and CPEs; and to automatically change connections between the BTSs and the CPEs according to two regimes operating in tandem, wherein
the first regimen selects CPEs and attempts to move them from busy BTSs to less busy BTSs: and
the second regimen filters CPE registration attempts on busy BTSs to divert the CPEs to less busy BTSs, to better balance the load.

2. A wireless broadband network management system according to claim 1, wherein the data is collected from element management systems in communication with the system: the data includes one or more of BTS performance data, logs of the element management systems, and CPE registration and migration history.

3. A wireless broadband network management system according to claim 2, wherein the system performs the following at each cycle of the two regimes:
creating a BTS load matrix;
minimising the matrix using BTS-CPE connectivity data;
using extrapolation techniques to create a future estimated snapshot of the network load if a CPE is moved:
comparing the estimated snapshot to a target bandwidth to move;
and then creating a difference or perturbation matrix.

4. A wireless broadband network management system according to claim 1, wherein the target bandwidth to move depends on the total resource usage of all CPEs according to their profiles, and a time-varying gain factor to take into account dynamic CPE traffic demands.

5. A wireless broadband network management system according to claim 1, wherein a CPE is moved from an original BTS to a new BTS to a new BTS if:
the load level of the new BTS is lower level than the load level of the original BTS; and,
the two BTSs are sufficiently different, that is the load level difference between the BTSs is at least a minimum load level difference.

6. A wireless broadband network management system according to claim 1, wherein the regimes operates in one of the following modes:
an overlay mode, where CPE is moved to a new BTS that has a direct capacity overlay as its original BTS; and
an overlay plus adjacent sector mode, where a CPE is moved to a new BTS that has a direct capacity overlay as its original BTS, or has an adjacent sector to its original BTS.

7. A wireless broadband network management system according to claim 1, wherein the system effects connection changes by:
telling a CPE that the BTS it is attached to is no longer a valid BTS allowed to service this CPE, and that the CPE is no longer nomadic.
probing the CPE which action initiates a CPE-driven BTS search, and it will then attach to BTSs it can see until it eventually ‘lands’ on the desired target BTS.
at that time setting the CPE to Nomadic with Preferred, with its Home BTS and Neighbouring BTS settings configured to prefer it to the new target BTS, and away from the original BTS:
and finally several tracking tasks are then created to watch the CPE over time and update any statistics for reference when contemplating future moves.

8. A wireless broadband network management system according to claim 1 wherein the system reduces its own workload over time by creating settled populations of CPEs that will stay on the optimal BTSs even after the CPE has been reset or power recycled.

9. A wireless broadband network management system according to claim 1 wherein the system further comprises a plurality of canaries programmed to receive commands from the system to run a series of tests to assess the network performance from the end customer point of view and report the results to the system.

10. A wireless broadband network management system according to claim 9, wherein the tests include Voice Over Internet Protocol (VOIP), Mean Opinion Score (MOS), HTTP throughput, packet loss, jitter and latency tests.

11. A wireless broadband network management system according to claim 1 wherein the system further performs regression tracking on the traffic data collected to track changes in network performance.

12. A wireless broadband network management system according to claim 1 wherein the system further uses the correlated data to compute a resource usage ratio representing the air interface efficiency between a CPE and a BTS.

13. A wireless broadband network management system according to claim 12, wherein the system uses the resource usage ratio to detect CPEs that violate their acceptable usage policy and when a violating CPE is detected, the system performs one or more or the following:
changing the speed descriptor of the CPE to a lower minimum resource allocation;
dropping the CPE to a lower descriptor class of service until the CPE complies with its acceptable usage policy;
sending warning messages to the CPE;
placing the CPE as the first choice of being moved to a new BTS, and increasing the number of times this CPE can be disturbed over time; and,
disabling the CPE.

14. A wireless broadband network management system according to claim 1 wherein the system analyses aggregate performance data of one or more CPEs and BTSs to answer natural language queries.

15. A wireless broadband network management system according to claim 1 wherein the system further performs BTS performance optimisation, comprising the steps of:
extracting BTS performance data from the data collected;
inferring BTS optimal settings for a variety of operating conditions,
computing an optimal settings for each BTS based known relationships among the BTSs, and
tuning the BTS settings and changing CPE connections to achieve the optimal settings computed.

16. A method for managing wireless broadband networks, comprising the steps of:
collecting data concerning traffic levels through the network base transceiver stations (BTSs), and the BTSs to which particular customer premise equipment (CPE) can connect using a data collection engine;
correlating the data collected;
monitoring overall network performance;
aggregating performance of one or more CPEs and BTSs;
detecting underperforming BTSs and CPEs; and,
automatically causing CPE connections and disconnections from a BTS to improve network performance in real time.

17. A software operable to implement the method according to claim 16.
